(19) United States
(12) Patent Application Publication
(10) Pub. No.: US 2025/0116857 A1
(43) Pub. Date: Apr. 10, 2025

(54) VARIABLE FOCAL LENGTH ADAPTIVE OPTICAL SYSTEMS

(71) Applicant: Blueshift, LLC dba Outward Technologies, Broomfield, CO (US)

(72) Inventors: Austin Kenneth Miller, Gold Hill, CO (US); Alan Thomas Carter, Arvada, CO (US); Ryan Garvey, Lafayette, CO (US)

(73) Assignee: Blueshift, LLC dba Outward Technologies, Broomfield, CO (US)

(21) Appl. No.: 18/985,543

(22) Filed: Dec. 18, 2024

Related U.S. Application Data
(63) Continuation-in-part of application No. 18/644,000, filed on Apr. 23, 2024.
(60) Provisional application No. 63/526,914, filed on Jul. 14, 2023.
(60) Provisional application No. 63/601,687, filed on Nov. 21, 2023.

(51) Int. Cl. G02B 26/08

(52) U.S. Cl. CPC G02B 26/08

(57) ABSTRACT

Variable focal length optical systems, in particular thermally controlled adaptive reflector variable focal length optical systems and annular force controlled adaptive reflector variable focal length optical systems. The variable focal length optical systems operate to produce concentrated light at a selectable focal length. The selectable focal length may be dynamically adjusted or controlled. A method of manufacturing the thermally controlled adaptive reflector.

### CROSS-REFERENCE TO RELATED APPLICATIONS

This application is a continuation-in-part nonprovisional patent application of and claims the benefit of U.S. patent application Ser. No. 18/644,000 titled “Tracking Lunar Articulating Mirror Array System” filed Apr. 23, 2024, which in turn claims the benefit of priority to U.S. Provisional Patent Application No. 63/526,914 titled “Lunar Articulating Mirror Array” filed Jul. 14, 2023, and U.S. Provisional Patent Application No. 63/601,687 titled “Tracking Lunar Articulating Mirror Array System” filed Nov. 21, 2023, the disclosures of all of which are hereby incorporated herein by reference in entirety.

### STATEMENT

This invention was made with government support under Contract Nos. 80NSSC22PA967 and 80NSSC23CA076, each awarded by the National Aeronautics and Space Administration (NASA). The government has certain rights in the invention.

### FIELD

The disclosure relates generally to variable focal length optical systems, and in particular to thermally controlled adaptive reflector variable focal length optical systems and annular force controlled adaptive reflector variable focal length optical systems.

### BACKGROUND

Lunar infrastructure construction traditionally seeks to leverage the abundance of solar energy and lunar regolith on the Moon. Conventional approaches range from a lunar microwave paving rover (Taylor and Meek, 2005; Clinton, 2022), polymer stabilization (Hintze et al., 2009), construction with sintered regolith bricks (Whittington and Parsapoor, 2022), extrusion-based methods (Isachenkov et al., 2021), and regolith concrete produced with the introduction of cement (Grossman, 2018). See Taylor, L. A. and T. T. Meek, “Microwave Sintering of Lunar Soil: Properties, Theory, and Practice,” J. Aerosp. Eng., vol. 18, no. 3, pp. 188-196, 2005, doi: 10.1061/(asce)0893-1321(2005)18:3(188); Clinton, R. G. “Overview of NASA's Moon-to-Mars Planetary Autonomous Construction Technology (MMPACT) and Demonstration and Qualification Missions Concepts,” Lunar Surface Innovation Consortium Excavation and Construction January 2022 Meeting, Jan. 26, 2022; Hintze, P. E., J. Curran, and T. Back, “Lunar surface stabilization via sintering or the use of heat cured polymers,” 47^{th} AIAA Aerosp. Sci. Meet. Incl. New Horizons Forum Aerosp. Expo., no. January 2009, 2009, doi: 10.2514/6.2009-1015; Whittington, A., & Parsapoor, A. (2022). Lower Cost Lunar Bricks: Energetics of Melting and Sintering Lunar Regolith Simulants. New Space, 10(2), 193-204; Isachenkov, M., Chugunov, S., Akhatov, I., & Shishkovsky, I. (2021). Regolith-based additive manufacturing for sustainable development of lunar infrastructure—An overview. Acta Astronautica, 180, 650-678; and Grossman, K. “Regolith-Based Construction Materials for Lunar and Martian Colonies,” University of Central Florida, 2018, each incorporated by reference in entirety for all purposes.

All of the above conventional methods of construction have pros and cons in implementation. Microwave-based and laser-based melting of regolith does not require additional binders; however, these heating methods have high electrical power requirements which cause scaling difficulties before an extensive electrical power infrastructure has been established on the Moon. Binder-based methods typically require 30% additives by weight which must be provided on Earth or by multi-step mining and extraction of sulfur from lunar mare deposits for regolith concrete. Solar sintering in a convective furnace is a promising method for producing regolith bricks and tiles without these electrical power and binder mass requirements, however, such a method requires extensive robotic manipulation for collecting and conveying regolith, and then placement of the tiles. The produced regolith bricks and tiles also have seams between each structural component which leads to ejecta and excavation of the subsurface when exposed to plume-surface interactions unless multiple layers of tiles or a geotextile is added.

The disclosure addresses these limitations and improves upon the existing, conventional approaches. The Tracking Lunar Articulating Mirror Array (LAMA) of the disclosure enables fabrication of pressurized and unpressurized structures on the Moon including landing/launch pads, roads, blast shields, and habitats using lunar regolith as the exclusive feedstock. No additional binders are required. This is achieved through a unique solar Fresnel adjustable focal length reflector for translating a concentrated solar spot across a regolith surface at a distance of meters to tens of meters. The system has relatively low electrical power requirements by relying on solar-thermal energy to fuse regolith through selective solar melting and liquid-phase sintering. Materials produced by the Tracking LAMA system may range from consolidated glass-ceramics with high strength to lightly sintered regolith to limit ejecta. Such capabilities are enabled through a lightweight design requiring minimal to no regolith handling for single-layer structures. The optics remain distanced from the site to avoid damage from dust and nearby surface operations. The Tracking LAMA system marks a significant advancement over conventional systems for large solar concentrators and represents a game-changing technology for lunar surface construction.

The disclosure also provides embodiments of variable focal length optical systems which may be used as part of the above LAMA systems or in other systems that require concentrated light of variable focal length. Lunar applications include LAMA mirror elements for lunar surface construction, power beaming, and resource extraction. In-space applications include very large aperture infrared space telescopes or solar concentrators. Applications on Earth include increasing concentration ratio of heliostats and heliostat arrays through focal length and surface shape adjustments of individual solar concentrating heliostats.

### SUMMARY

The Tracking LAMA redirects solar flux with controllable concentration ratios and can replicate any reflective optic geometry. The system redirects solar radiation using a masted heliostat array and may track a moving target or translate a concentrated solar spot across a fixed surface. The face of the array is composed of independently actuated concentrating mirror elements to form a variable focal position Fresnel reflector. In one aspect, the lunar articulating mirror array system may redirect solar flux with controllable concentration ratios and may replicate any reflective optic geometry, in some configurations with use of adaptive optics for the concentrating mirror elements.

The system may supply solar energy at sufficient concentrations to power a variety of thermal processes such as selective melting, liquid phase sintering, and vapor phase pyrolysis of regolith. The system may direct solar flux at lower concentrations to photovoltaics or rovers for power and thermal management.

The tracking Lunar Articulating Mirror Array is composed of a solar concentrating Fresnel reflector with selectable focal position, and may be utilized in at least two unique areas of the lunar industry to support NASA's Artemis program:
Construction. The tracking LAMA concentrates solar energy with sufficient power density to selectively sinter and melt regolith to distances of up to 30 m for a full-scale system. Materials produced by selectively melting regolith have been proven to have properties exceeding that of terrestrial grade concrete and are sufficient for use in various horizontal structures such as landing and launch pads and roadways. Also, the system may cause liquid phase sintering on the lunar surface at lower concentration ratios and distances significantly farther than 25 m. The technology may be used to rapidly treat large areas of the lunar surface, prevent the generation of ejecta from plume-surface interactions, and mitigate against dust transported by electrostatic levitation.
In-space solar management. The tracking LAMA may replicate any spherically or parabolically concentrating reflective optic through a variable geometry Fresnel reflector that enables the system to redirect solar energy at controllable concentration ratios. Processes requiring high temperatures are thus able to make use of highly concentrated energy, and photovoltaics make use of lower solar concentrations while benefiting from the increased power generation efficiencies at greater than 1 Sun concentrations. Additionally, the system may illuminate and track equipment, such as rovers, operating in the permanently shadowed regions for power and thermal considerations. Lastly, equipment which becomes shadowed due to the lunar diurnal cycle, seasonal variations, or new lunar constructions may be illuminated by tracking LAMA to facilitate continuous operations.

NASA applications include construction of large horizontal structures, layer-wise additive construction, treatment of regolith surfaces to minimize ejecta from PSI's, and solar-thermal power generation on the lunar surface. The tracking LAMA provides a robust construction tool for addressing NASA's needs for establishing permanent lunar infrastructure while relying on abundant solar-thermal power and ISRU materials.

Potential non-NASA applications include: increased pointing accuracy of heliostat fields for higher efficiency concentrated solar-thermal power plants on Earth; improved design of heliostat geometries to enable higher temperature solar-thermal reactors for industrial decarbonization; and In-Space Servicing, Assembly, and Manufacturing (ISAM) in low-Earth orbit for DoD and commercial customers.

Compared to the current state of the art being developed for lunar construction, the tracking LAMA system provides numerous benefits/complements, for example:
High strength construction material from in-situ resources and energy. Concentrated Solar Energy (CSE) is used to produce specimens with high compression strength, ductility, and toughness comparable to terrestrial concrete using lunar highlands simulant and a full melt process. This material will be produced from in situ regolith and readily available solar energy.
Rapid construction rates. Considering the divergence of incoming solar radiation, the power density and time to melt lunar highlands regolith observed in similar solar melting processes, and material handling requirements, the tracking LAMA system may construct a MMPACT DM-2 LLP in less than 2.5 Earth days.
In situ process monitoring. The system performs the process on the construction surface. Optical imaging of the construction surface may be obtained prior and following exposure to CSE. Image analysis is then performed to verify proper fusion and densification of the regolith. The hot spot also moves at a slow enough rate to allow for easy monitoring of the melt pool emissions, and optical thermography will be able to verify proper process temperatures.
Protected optics. The tracking LAMA places the Fresnel reflector on a mast at elevations up to 15 m. The sensitive optics are raised above dust clouds generated by nearby surface operations and electrostatic levitation (See, e.g., “The Lunar Dust Environment” by Grün et al, Planet. Space Sci., vol. 59, no. 14, pp. 1672-1680, 2011, incorporated by reference in entirety for all purposes.)

In addition, the system has several secondary benefits, for example:
The resulting construction material produced by the lunar regolith is easily repairable by the tracking LAMA system.
Surface cracks may be able to be remelted and healed following resolidification.
The system also requires no consumable materials from Earth. Almost all terrestrial additive fully melted processes, such as selective laser melting, require a build plate onto which material is deposited. However, the process has proven capable of producing fully melted parts on a bed of regolith while using no additives and minimal beneficiation.
The tracking LAMA system is able to redirect solar radiation from higher elevations and with controllable concentrations. While deployed at the lunar poles, the LAMA system is able to escape shadows generated by geological features or new surface constructions by extending vertically. That solar energy can be concentrated for continued construction or projected at a lower concentration onto shadowed photovoltaics.

In one embodiment, a tracking mirror array system is disclosed, the system comprising: a body comprising a body face; a set of adaptive mirror elements forming a mirror array, each adaptive mirror element attached to the body face and configured to articulate about at least two axes, each adaptive mirror element having a mirror element first focal length; set of mirror orientation actuators, each mirror orientation actuator configured to orient a respective adaptive mirror element about the at least two axes; a mirror element sensor configured to measure an orientation of each adaptive mirror element relative to the body face; a set of mirror focal length actuators, each mirror focal length actuator configured to set a respective adaptive mirror element to a respective mirror element second focal length different than the respective mirror element first focal length; a body actuator configured to orient the body about at least one axis; a processor; and a controller in communication with the processor and configured to control the body actuator, the set of mirror actuators, and the set of mirror focal length actuators; wherein: each of the set of adaptive mirror elements operate to receive an input light pattern and reflect the input light pattern to produce a mirror element output light pattern; each of the set of mirror actuators operate to orient each of the respective adaptive mirror elements to direct the respective mirror element output light pattern to a common spot location; and each of the set of mirror focal length actuators operate to adjust each of the respective adaptive mirror elements to the respective mirror element second focal length.

In one aspect, the system further comprises a body mast coupled to the body and configured to position the body at a selected elevation above ground. In another aspect, the system further comprises a mobile platform coupled to the body mast and configured to translate the tracking articulating mirror array system. In another aspect, the input light pattern is provided by the Sun. In another aspect, each of the adaptive mirror elements are configured to form parabolic mirrors upon actuation of the respective mirror focal length actuator. In another aspect, the common spot location enables at least one of sintering and power generation. In another aspect, the common spot location translates. In another aspect, the system is configured to operate in coordination with an external system, and the external system comprises a fixed reactor for at least one of oxygen extraction from lunar regolith and for extrusion of slag.

In another embodiment, a method of using at least two mirror array systems is disclosed, the method comprising: providing a first mirror array system and a second mirror system, each comprising: a body comprising a body face; a set of mirror elements forming a mirror array, each mirror element attached to the body face and configured to articulate about at least two axes; a set of mirror actuators, each mirror actuator configured to articulate a respective mirror element about the at least two axes; a mirror element sensor to measure the rotation between each mirror element and the body face; a body actuator configured to articulate the body about at least one axis; a processor; and a controller in communication with the processor and configured to control the body actuator and the set of mirror actuators; orienting the body of the first mirror array system to receive an input light pattern; receiving the input light pattern at each of the set of mirror elements of the first articulating mirror array system; operating each of the set of mirror actuators of the first mirror array system to direct a reflection of the incoming light pattern to the set of mirror elements of the second mirror array system; reflecting a received input light pattern received at each of the set of mirror elements of the first mirror array system to the set of mirror elements of the second mirror array system; orienting the body of the second mirror array system to receive the input light pattern; receiving the input light pattern at each of the set of mirror elements of the second mirror array system; operating each of the set of mirror actuators of the second mirror array system to direct a reflection of the incoming light pattern to a common spot location; reflecting a received input light pattern received at each of the set of mirror elements of the second mirror array system to the common spot location; and irradiating the common spot location.

In one aspect, common spot location enables at least one of sintering and power generation. In another aspect, the common spot location translates. In another aspect, at least one mirror array system further comprises a mobile platform coupled to the respective body mast and is configured to translate the respective mirror array system. In another aspect, the input light pattern is provided by the Sun. In another aspect, the mirror elements of each mirror array system are parabolic mirrors. In another aspect, the mirror elements of each mirror array system are adaptive mirror elements of adjustable focal length.

In yet another embodiment, a tracking mirror array system is disclosed, the system comprising: a body comprising a body face; a set of at least two adaptive mirror elements forming a mirror array, each adaptive mirror element attached to the body face and configured to articulate about at least two axes, each adaptive mirror element having a static mirror element focal length and a mirror reflective face; a set of mirror orientation actuators, each mirror orientation actuator configured to orient a respective adaptive mirror element about the at least two axes; a set of mirror focal length actuators, each mirror focal length actuator configured to set a respective adaptive mirror element to a respective first focal length different than the respective static mirror element focal length; a body actuator configured to orient the body about at least one axis; a processor; and a controller in communication with the processor and configured to control the body actuator, the set of mirror actuators, and the set of mirror focal length actuators; wherein: each of the set of at least two adaptive mirror elements operate to receive an input light pattern and reflect the input light pattern to produce a mirror element output light pattern; each of the set of mirror actuators operate to orient each of the respective adaptive mirror elements to direct the respective mirror element output light pattern to a common spot location; each of the set of mirror focal length actuators operate to adjust each of the respective adaptive mirror elements to the respective first focal length; and each of the mirror focal length actuators operate to impart a force to each respective adaptive mirror element to form the respective mirror reflective face into one of a parabolic or conical shape.

In one aspect, each of the set of mirror focal length actuators operate to adjust each of the respective adaptive mirror elements by way of one of an annular push force and a point-pull force. In another aspect, the common spot location enables at least one of sintering and power generation. In another aspect, the common spot location translates. In another aspect, the system is configured to operate in coordination with an external system, the external system comprising a fixed reactor for at least one of oxygen extraction from lunar regolith and for extrusion of slag.

In one embodiment, an adaptive reflector system is described, the system comprising: an adaptive reflector body comprising: a mirror plate comprising an outer mirror surface; a ring coupled to the outer mirror surface at an inner circumference of the outer mirror surface, the ring configured with a set of apertures passing through the outer mirror surface; a set of fasteners passing through the set of apertures; and a pull plate connected to the set of fasteners; at least one actuator connected to the pull plate, the at least one actuator operating to impart a pulling force to the pull plate; wherein: when a push force is imparted to the outer circumference, the mirror plate forms a parabolic shape.

In one aspect, the at least one actuator is connected to the pull plate at a central axis of the adaptive reflector body. In another aspect, the adaptive reflector body further comprises a set of puller springs connected to the pull plate at a plurality of circumferences of the pull plate, the set of puller springs imparting a pretension to the pull plate. In another aspect, the system of claim 1, further comprising an actuator assembly operating to position an orientation of the adaptive reflector body. In another aspect, the system further comprises an illumination spot sensor configured to measure an illumination spot character provided to the controller, wherein the controller determines an inferred outer mirror surface shape.

In another embodiment, an adaptive reflector system is described, the system comprising: an adaptive reflector body comprising: a mirror plate comprising an outer mirror surface; a ring coupled to a lower surface of the mirror plate at an inner circumference of the mirror plate; an outer strut ring coupled to a lower surface of the mirror plate; and an inner strut ring coupled to the lower surface of the mirror plate; a set of outer struts connected to the outer strut ring; a set of inner struts connected to the inner strut ring; at least one actuator coupled to the set of inner struts, the at least one actuator operating to impart a pulling force to the inner strut ring; wherein: when a push force is imparted to the outer strut ring, the mirror plate forms a parabolic shape.

In one aspect, the adaptive reflector body further comprises a set of puller springs connected to the inner strut ring, the set of puller springs imparting a pretension to the inner strut ring. In another aspect, the system further comprises an actuator assembly operating to position an orientation of the adaptive reflector body. In another aspect, the system further comprises a protective layer disposed on the outer mirror surface. In another aspect, the system further comprises an illumination spot sensor configured to measure an illumination spot character provided to the controller, wherein the controller determines an outer mirror surface shape.

In yet another embodiment, an adaptive reflector system is described, the system comprising: an adaptive reflector body comprising a front surface portion having a first thermal expansion coefficient and a substrate portion having a second thermal expansion coefficient, the adaptive reflector body having a first sagitta with a first focal length when the adaptive reflector body is at a first temperature and having a first outer reflective surface; at least one thermal unit configured to set a thermal energy output and provide the thermal energy output to the adaptive reflector body, the thermal energy output is at least one of a heating output and a cooling output; at one insulation layer positioned adjacent the at least one thermal unit and configured to absorb at least some of the thermal energy output; and a controller configured to control the thermal energy output of the at least one thermal unit; wherein: the thermal energy output provided to or removed from the adaptive reflector body changes the adaptive reflector body to: i) a second temperature, and ii) a second sagitta with a second focal length.

In one aspect, the controller receives a user selected focal length, and the user selected focal length is the second focal length. In another aspect, the at least one thermal unit is a plurality of thermal units comprising at least one embedded thermal unit positioned within the adaptive reflector body. In another aspect, the system further comprises a protective layer disposed on the outer mirror surface.

In yet another embodiment, a method of manufacture of an adaptive reflector is described, the method comprising: receiving a set of adaptive reflector operating requirements; positioning a set of additive manufacturing tools and a set of manufacturing materials within a temperature-controlled chamber; selecting a set of additive manufacturing parameters consistent with the adaptive reflector operating requirements; performing additive manufacturing of the adaptive reflector within the temperature-controlled chamber using the set of additive manufacturing tools and the set of manufacturing materials; removing the adaptive reflector from the temperature-controlled chamber; wherein: the performing additive manufacturing step secures a set of selectable thermal strains in the adaptive reflector, the set of selectable thermal strains consistent with the adaptive reflector operating requirements.

In one aspect, the set of adaptive reflector operating requirements comprise a focal length at an operating temperature of the adaptive reflector. In another aspect, the set of manufacturing materials comprises a substrate and a front surface. In another aspect, set of additive manufacturing parameters comprise a substrate thickness and a front surface thickness. In another aspect, the method further comprises at least one of the steps of polishing the adaptive reflector and applying a protective layer to an outer surface of the adaptive reflector. In another aspect, the additive manufacturing is ultrasonic additive manufacturing.

By way of providing additional background, context, and to further satisfy the written description requirements of 35 U.S.C. § 112, the following set of references are incorporated by reference in entirety: U.S. Pat. No. 7,192,146 entitled “Solar concentrator array with grouped adjustable elements” to Gross; U.S. Pat. No. 9,995,507 entitled “Systems for cost-effective concentration and utilization of solar energy” to Norman; U.S. Pat. No. 10,768,398 entitled “Solar-concentrating solarization apparatus, methods, and applications” to Lal; U.S. Pat. No. 7,834,303 entitled “Multi-element concentrator system” to Fatehi; U.S. Pat. No. 9,995,507 entitled “System for Cost Effective Concentration and Utilization of Solar Energy” to Norman; US Patent Application Publication Nos. 2014/0261387 entitled “Concentrating solar collector and pre-formed Fresnel array reflector panel” to Hansen and 2010/0294266 entitled “Concentrated Solar Thermal Energy Collection” to Fung; WIPO Publ. No. WO2017016550 entitled “Method and device for the thermal treatment of sand” to Frank; European Patent Document No. EP 2,799,794 entitled “Apparatus for Concentrating Energy” to Komrakov; and “Commercial lunar propellant architecture: A collaborative study of lunar propellant production” published March 2019 in Reach, Volume 13.

The term “regolith” means any blanket of unconsolidated, loose, heterogeneous superficial deposits that covers solid rock, and may include soil, dust, broken rocks, and other related materials. Regolith is present at least on Earth, the Moon, Mars, and some asteroids.

The term “heliostat” is a device that includes a mirror which turns so as to keep reflecting sunlight toward a predetermined target, compensating for the sun's apparent motions in the sky.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The terms “determine,” “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The disclosed methods and/or systems may be readily implemented in software and/or firmware that can be stored on a storage medium to improve the performance of: a programmed general-purpose computer with the cooperation of a controller and memory, a special purpose computer, a microprocessor, or the like. In these instances, the systems and methods can be implemented as programs embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

Various embodiments may also or alternatively be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The disclosure will be readily understood by the following detailed description in conjunction with the accompanying drawings, wherein like reference numerals designate like elements. The elements of the drawings are not necessarily to scale relative to each other. Identical reference numerals have been used, where possible, to designate identical features that are common to the figures.

FIG. 1 is a schematic representation of one embodiment of a tracking lunar articulating mirror array system;

FIG. 2 is a flow chart of a method of use of the tracking lunar articulating mirror array system of FIG. 1;

FIG. 3 is a schematic representation of the tracking lunar articulating mirror array system of FIG. 1 operating with a second tracking lunar articulating mirror array system;

FIG. 4 is a flow chart of a method of use of the multiple tracking lunar articulating mirror array system of FIG. 3;

FIG. 5 is a cut-away representation of one embodiment of an adaptive mirror element;

FIG. 6 is a cut-away representation of an inner threaded ring annular push adaptive mirror element;

FIG. 7A is a top view of another embodiment of an adaptive mirror element;

FIG. 7B is a front view of the adaptive mirror element of FIG. 7A;

FIG. 7C is a perspective view of the adaptive mirror element of FIG. 7A;

FIG. 7D is a side view of the adaptive mirror element of FIG. 7A;

FIG. 8 depicts a tracking lunar articulating mirror array system operating with a Solar Concentrating Oxygen Reactor for Continuous Heating and Extrusion of Regolith (SCORCHER) system to form a Lunar Refining System;

FIG. 9 depicts a tracking lunar articulating mirror array system operating with a Sintering End Effector for Regolith (SEER);

FIG. 10A depicts a side view of a tracking lunar articulating mirror array system operating with a regolith smoothing and deposition rover;

FIG. 10B is a perspective view of the tracking lunar articulating mirror array system operating with the regolith smoothing and deposition rover of FIG. 10A;

FIG. 11A depicts a side view of a tracking lunar articulating mirror array system operating with a SEER-mounted rover;

FIG. 11B a perspective view of the tracking lunar articulating mirror array system operating with the SEER-mounted rover of FIG. 11A;

FIG. 11C is another side view of a tracking lunar articulating mirror array system operating with a SEER-mounted rover;

FIG. 12 is a flow chart of one embodiment of a method of manufacture of a thermally controlled adaptive reflector;

FIG. 13 is a schematic representation of one embodiment of the thermally controlled adaptive reflector system manufactured using the flow chart of FIG. 12;

FIG. 14 is schematic representation of one embodiment of an annular controlled adaptive reflector system;

FIG. 15A is a perspective view of an embodiment of the annular controlled adaptive reflector system of FIG. 14;

FIG. 15B is a side view of the annular controlled adaptive reflector system of FIG. 15A;

FIG. 16A is a perspective view of another embodiment of the annular controlled adaptive reflector system of FIG. 14;

FIG. 16B is a cutaway side view of the annular controlled adaptive reflector system of FIG. 16B;

FIG. 17A is a perspective top view of yet another embodiment of the annular controlled adaptive reflector system of FIG. 14;

FIG. 17B is a perspective bottom view of the annular controlled adaptive reflector system of FIG. 17A;

FIG. 18A is cut-away side view of an annular pull embodiment of the annular controlled adaptive reflector system of FIG. 14;

FIG. 18B is cut-away side view of a point pull embodiment of the annular controlled adaptive reflector system of FIG. 14; and

FIG. 18C is cut-away side view of an annular push embodiment of the annular controlled adaptive reflector system of FIG. 14.

It should be understood that the proportions and dimensions (either relative or absolute) of the various features and elements (and collections and groupings thereof) and the boundaries, separations, and positional relationships presented there between, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

Reference will now be made in detail to representative embodiments. The following descriptions are not intended to limit the embodiments to one preferred embodiment. To the contrary, it is intended to cover alternatives, modifications, and equivalents as can be included within the spirit and scope of the described embodiments as defined, for example, by the appended claims.

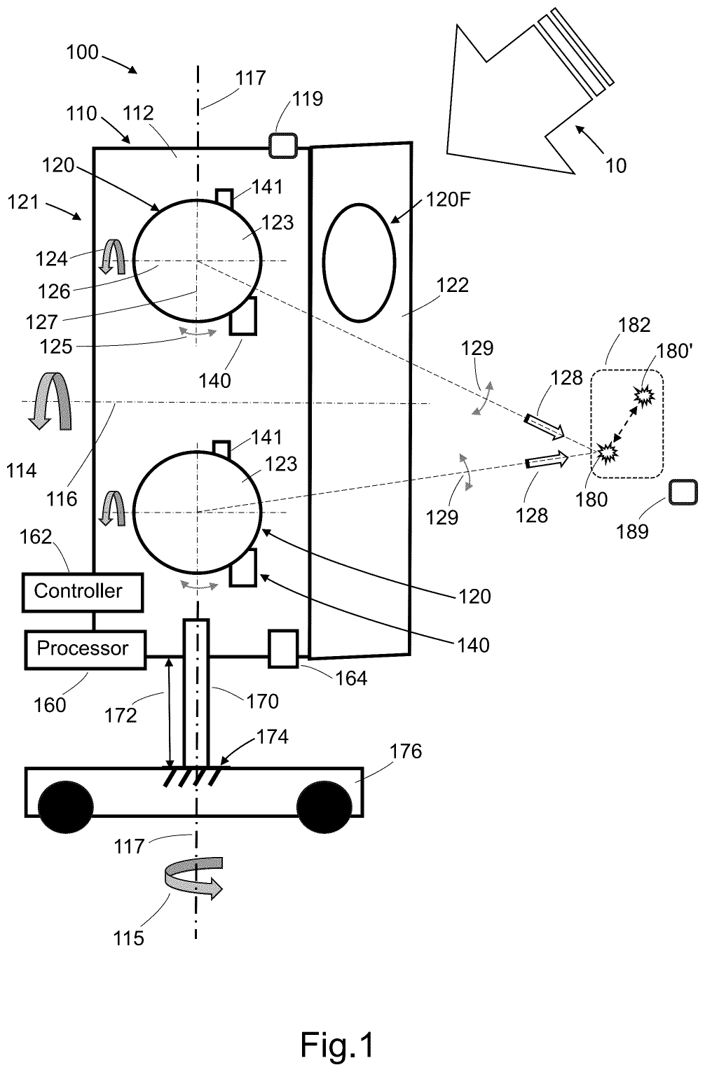

The disclosed devices, systems, and methods of use will be described with reference to FIGS. 1 through 18A-C.

Generally, systems and methods to provide a tracking lunar articulating mirror array system and method of use, and systems, methods of use, and methods of manufacture of variable focal length optical systems, are provided. The term “system” or “LAMA” or “T-LAMA” may be used to refer to an embodiment of the tracking lunar articulating mirror array system. The term “method” may be used to describe an embodiment of a method of use of the tracking lunar articulating mirror array system. The tracking lunar articulating mirror array system and method of use may be used, for example, in powering solar thermal processes in a lunar environment. The system redirects solar radiation using a masted heliostat array and may track a moving target or translate a concentrated solar spot across a fixed surface. The face of the array is composed of a set of independently actuated and focal length adjustable concentrating mirrors to form a variable focal position Fresnel reflector. In one aspect, the lunar articulating mirror array system may redirect solar flux with controllable concentration ratios and may replicate any reflective optic geometry, in some configurations with use of adaptive optics. (the phrase “adaptive optics” refers to a technique of precisely deforming a mirror to alter the optics of the mirror, commonly to compensate for light distortion but also as a means to alter the mirror's notional (undeformed) optical characteristics. In some embodiments, one or more concentrating mirrors are adaptive concentrating mirrors (described below).

Although the disclosed devices, systems, and methods of use will be principally described relative to a lunar articulating mirror array system for use in lunar applications, the devices, systems, and methods of use have other applications. For example, the method and/or devices may be used in terrestrial applications such as solar power generation and industrial decarbonization. Other applications or uses are possible.

The phrase “focal length” refers to a measure of how strongly an optical component converges or diverges light.

The phrase “light pattern” refers to all characteristics of an emitted light, such as brightness, profile angle, color, pixilation, etc. The phrase “light profile” refers to the angle of the emitted cone of light; light profile is one characteristic of a light pattern.

The term “sintering” means the process of forming a solid mass of material by heat without melting the material to the point of liquefaction and may include solid state sintering where no melting occurs or liquid phase sintering where an additive is melted to draw unmelted particles towards one another and bond them together.

The phrase “NASA sintering” means the process of melting <50% of regolith to bond the rest of the unmelted regolith together.

The term “melting” means the process of forming a liquid mass of material by heating a portion or all of the material to the point of liquefaction.

The phrase “additive manufacturing” or “AM” means a process that involves production of a component through successive additions of layers, which is the opposite of traditional subtractive manufacturing, where parts and pieces are removed during construction of a product.

With attention to FIG. 1, one embodiment of a tracking lunar articulating mirror array system 100 is described. Most generally, the tracking lunar articulating mirror array system 100 comprises a body 110 with a body face 112, a set of two (operating) adaptive mirror elements 120 each with a mirror reflective face 123 forming a mirror array 121 with folded array portion 122 comprising adaptive mirror element 120F, the mirror array 121 attached or coupled or engaged with the body 110 such as the body face 112, a set of two mirror orientation actuators 140 (each associated with a respective mirror element 120), a set of two mirror focal length actuators 141 (each associated with a respective mirror element 120), a body mast 170 connected with the body 110, a body actuator 164, a stabilizing base 174 connected with the body mast 170, a rover 176 connected with the body mast 170 and/or connected with the stabilizing base 174, a processor 160 and a controller 162. (Adaptive mirror element 120F is depicted disposed on folded array portion 122 with the folded array portion 122 not fully unfolded and thus in an interim non-operational state; upon the folded array portion 122 being fully unfolded, the adaptive mirror element 120F may become operational; additional components associated with the adaptive mirror element 120F are not shown for clarity, e.g., actuator). Note that any particular set of adaptive mirror elements 120 may be configured with unique capabilities or optical characteristics. For example, one adaptive mirror element 120 may have a first range of adjustable focal length and another adaptive mirror element 120 have a second range of adjustable focal length different than the first range of adjustable focal length. Also, some mirror elements may not comprise adaptive optical capabilities. Furthermore, the phrase “adaptive mirror element” is not intended to be limiting as to the capabilities or configuration of any particular or set of mirror elements. One or more adaptive mirror elements 120 may be referred to as mirror elements 120.

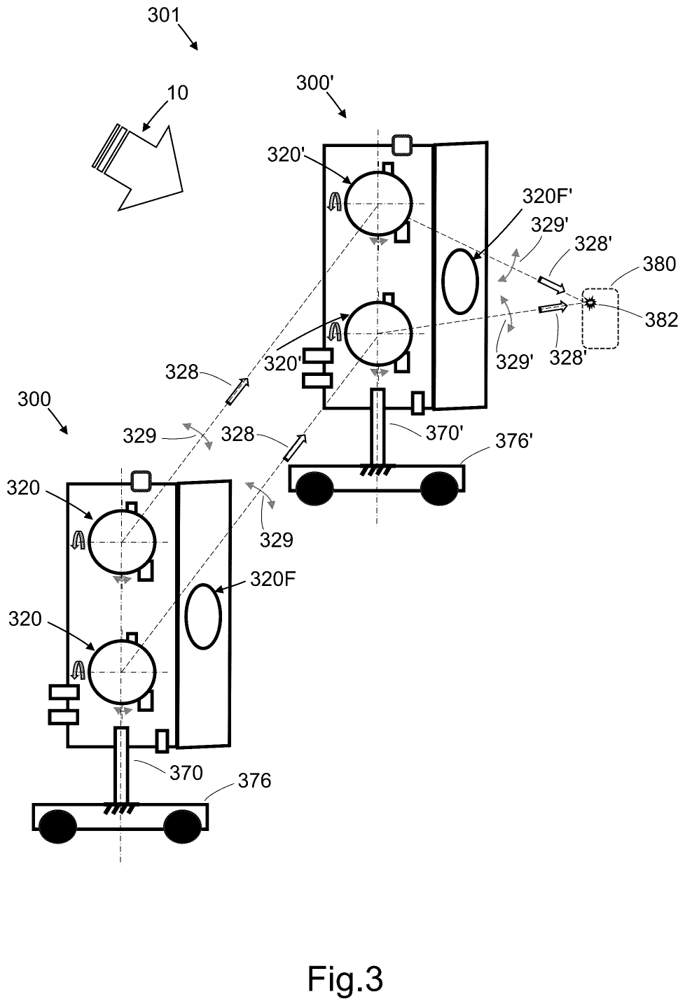

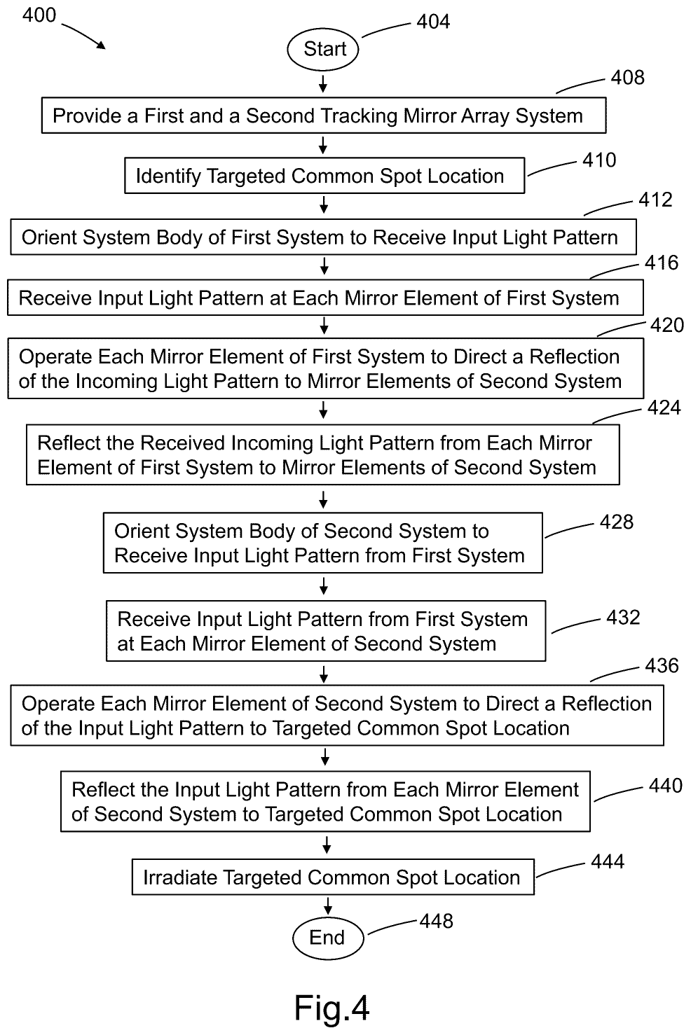

The extendable mast 170 may be mounted on a mobile platform such as robotic rover 176 to position the tracking LAMA relative to the structure and Sun to allow for continuous construction during the lunar day. Multiple tracking LAMA systems may be used independently or collaboratively to form a construction system that may directly irradiate a common spot location. In an alternate embodiment, a first set of tracking LAMA systems may be used to reflect sunlight onto a second set of tracking LAMA systems to then reflect this sunlight to a common spot location (see e.g., FIGS. 3-4). The mobile platform may move or maneuver as a wheeled vehicle or a rocket propelled lander, and/or may be crane mounted, tracked, or configured as a rail vehicle, or may be pulled by a separate vehicle by way of sled, skids, or rails, or by other methods known to those skilled in the art.

Each of the set of adaptive mirror elements 120 (there are two in total in the embodiment of FIG. 1) operate to receive an input light pattern 10 and reflect the input light pattern 10 to produce a respective mirror element output light pattern 128 (one such mirror element light pattern 128 is produced from each of the adaptive mirror elements 120). Each of the set of mirror orientation actuators 140 (there is one mirror orientation actuator 140 for each of the mirror elements 120) operate to articulate the respective adaptive mirror element 120 to direct the respective mirror element light pattern 128 to a common spot location 180. Each of the set of mirror focal length actuators 141 (there is one mirror focal length actuator 141 for each of the mirror elements 120) operate to change or set or adjust a respective mirror element 120 to a selectable mirror element focal length. In one embodiment, one or more mirror focal length actuators 141 operate to change or set or adjust a particular adaptive mirror element 120 from a mirror element first focal length to a mirror element second focal length, the mirror element first focal length being the focal length of the adaptive mirror element 120 in a natural state undergoing no adjustment or actuation from a mirror focal length actuator 141.

One or more adaptive mirror elements 120 may be operated by controller 162 and mirror actuators 140 (and/or mirror focal length actuators 141) to move or traverse the respective mirror element light pattern 128 at directed locations, such as common spot location 180 and common spot location 180′. Note that in some configurations, multiple common spot locations 180 may be irradiated by the set of adaptive mirror elements 120 at the same time. Stated another way, the set of adaptive mirror elements may be configured to illuminate or irradiate a set of identified spots at multiple locations simultaneously or in a selectable sequence.

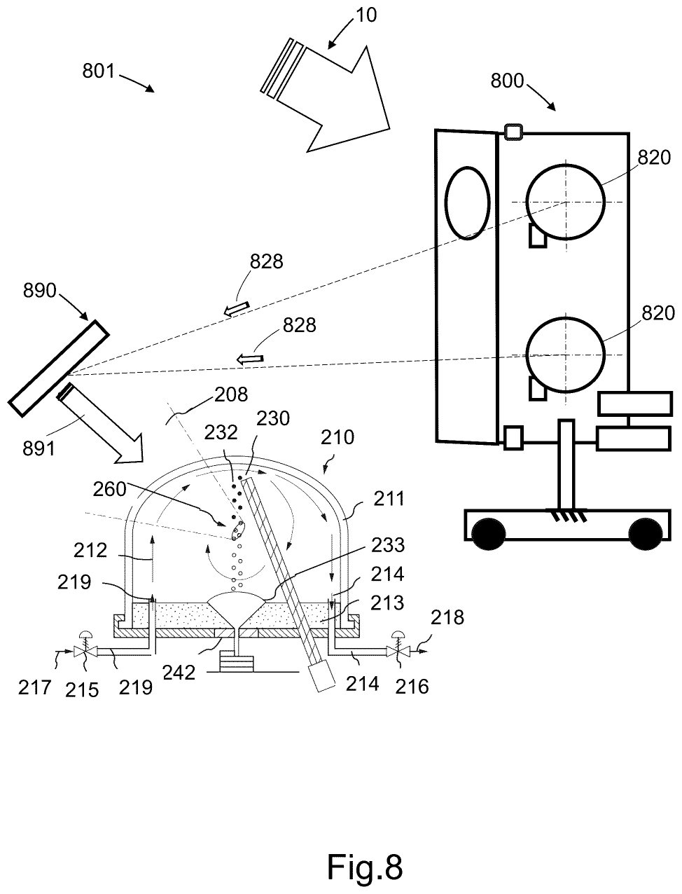

Additionally, or alternatively, the adaptive mirror elements 120 may direct their respective mirror element light pattern 128 to an external system 182. The external system 182 may be any number of external systems, such, for example, the Solar Concentrating Oxygen Reactor for Continuous Heating and Extrusion of Regolith (“SCORCHER”) system of U.S. Patent Ser. No. 17/668,206 filed Feb. 9, 2022 to Brewer et al, the solar concentrator reactor system of U.S. Patent Ser. No. 17/676,919 filed Feb. 22, 2022 to Brewer et al, and the Sintering End Effector for Regolith (“SEER”) system of U.S. Patent Ser. No. 17/983,266 to Brewer et al filed Nov. 8, 2022, each of which are incorporated by reference in their entireties for all purposes. The engagement of the tracking lunar articulating mirror array system 100 with such external systems 182 is described in more detail below (see, e.g., FIGS. 8, 9, 10A-B, and 11A-C). The tracking lunar articulating mirror array system of the disclosure may serve, e.g., as the input or primary or initial light source to an external system. For example, the tracking lunar articulating mirror array system may serve as the “primary concentrator” light source for the above-referenced SEER system.

The set of adaptive mirror elements may differ in number (e.g., there could be only one mirror, or there could be four mirrors, etc. Also, the locations of the mirrors may vary—FIG. 1 shows two mirrors aligned vertically; other configurations are possible, e.g., mirrors aligned horizontally, etc., as known to those skilled in the art).

Stated another way, the tracking LAMA consists of an articulating array of reflective adaptive mirror elements installed on an extendable mast 170. (The reflective mirror elements may be any of several geometries and have any of several selectable optical characteristics, e.g., a parabolic geometry thus providing a parabolic optical mirror, a conical geometry, etc., and other shapes providing particular optics as known to those skilled in the art). The system orients the body face relative to the sun location and common spot location by adjusting a rotational joint at the base of the mast-rover junction as well as optionally the angle of inclination of the array. While translating the spot, the system adjusts orientation and/or reflective surface configuration of each mirror element to control focal length and to maintain the concentrated solar spot on the surface of the lunar construction. The orientation of each mirror element may be adjusted by a ganged assembly, or by independent actuators mounted on each element.

As non-limiting embodiments, two methods of determining desired focal length may be considered: 1) open loop control considering concentrator position and topological survey information of the construction site and 2) closed loop control considering image processing of, and emissions from the melt pool and/or considering the true orientation of each mirror relative to the body face and common spot location.

Mirror elements (in one embodiment, parabolic mirror elements) provide primary solar concentration and simplify actuation of the system by reducing the total number mirror elements required for melting regolith as compared to flat mirror elements.

The body 110 is configured to secure the set of adaptive mirror elements 120, the respective mirror orientation actuators 140 of each mirror element, and the set of respective mirror focal length actuators 141 of each adaptive mirror element. The body face 112 of the body 110 is configured to receive or secure the set of mirror elements 120 and the respective mirror orientation actuator 140 and mirror focal length actuator of each mirror element. The body 110 and the body face 112, and thus the set of adaptive mirror elements 120 in entirety (that is, as a unit or as the entire mirror array 121), may rotate about one or both of the vertical axis 117 (akin to a yaw or azimuth rotation) and about the horizontal axis 116 (akin to a pitch or an elevation rotation). The rotation of the body 110 and body face 112 along the vertical axis 117 may be about the centerline axis of the body mast 170. The one or more rotations of the body 110 and body face 112 are enabled by the body actuator 164. The body actuator 164 is configured to articulate the body 110 and body face 112 about the axis 117 and the axis 116. In some embodiments, the body actuator is configured to articulate the body 110 and/or body face 112 about at least two axes. Note that because the mirror array 121 is attached to or secured to or coupled to the body 110 and/or the body face 112, a rotation or any movement of the body and/or body face by the body actuator 164 in turn rotates or moves the mirror array 121. For example, in one embodiment, the body actuator 164 operates to articulate the mirror array 121 to track the input light pattern 10.

Each mirror orientation actuator 140 is configured to articulate a respective mirror element 120 about one or both of a local mirror horizontal axis 126 (a “tilt” axis) and a normal axis relative to the mirror (a “twist” axis). Stated another way, the orientation mirror actuator(s) operates to provide a local horizontal rotation 124 of a respective mirror element 120 about a local horizontal axis 126 and to provide a local twist rotation 125 of a respective mirror element 120 about a local normal to the mirror. The result of the “tilt and twist” configuration is a mirror element that may be oriented to project or reflect an incoming or received input light pattern to produce a mirror element output light pattern 128 along a path or vector of a determined or controllable azimuth and elevation angle (such angles represented by steering arrow 129), and to thus direct that mirror element output light pattern to the common spot location 180, 180′. Additional details regarding the operation of the mirror actuator, the mirror elements, etc. are provided in U.S. Pat Appl No. 63/526,914 filed Jul. 14, 2023, to Garvey et al, incorporated by reference in entirety for all purposes.

In an alternate embodiment, the mirror elements operate in a tip and tilt configuration. The result of the “tip and tilt” configuration is identical to that of the above “tilt and twist” configuration, i.e., the result is a mirror element that may be oriented to project or reflect an incoming or received input light pattern to produce a mirror element light pattern along a path or vector of a determined or controllable azimuth and elevation angle, and to thus direct that mirror element light pattern to the common spot location.

Other configurations of mirror actuation and control are possible, to include a “tilt and yaw” configuration in which a mirror element operates to rotate about the local mirror horizontal axis 126 (a “tilt” axis) and to rotate about a local mirror vertical axis 127. Again, as with the above two mirror element actuation/control configurations, the result of the “tilt and yaw” configuration is a mirror element that may be oriented to project or reflect an incoming or received input light pattern to produce a mirror element light pattern along a path or vector of a determined or controllable azimuth and elevation angle, and to thus direct that mirror element light pattern to the common spot location.

Note that although the above mirror element actuation/control configurations or embodiments described one mirror element, in practice such configurations would be applied to a set of mirror elements which compose a mirror array.

In some embodiments, the mirror elements forming a mirror array are configured in different actuation/control configurations, e.g., a set of mirror elements are configured in a “tilt and twist” configuration and some in a “tip and tilt” configuration. In some embodiments, a given mirror actuator 140 operates or actuates more than one mirror element 120. In some embodiments, each mirror element is engaged with an actuator in any configuration that enables the mirror element to adjust in each of elevation and azimuth angle.

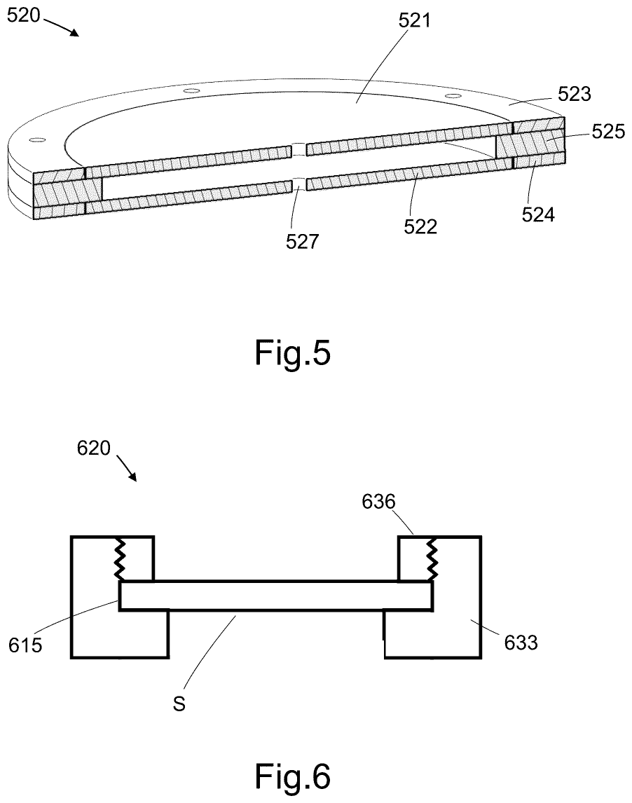

One or more mirror elements 120 may be configured with adaptive optical control by way of the respective mirror focal length actuator 141, such adaptive optical control operating to control the direction, focal length, and other optical characteristics of the mirror element light pattern 128 of each mirror element 120. Various embodiments of mirror elements with adaptive optics are described below with respect to FIGS. 5, 6, and 7A-D.

In one embodiment, one or more of the mirror elements 120 are rigid and are not adaptable so as to alter optical characteristics such as focal length, but instead are of a fixed design and configuration, such as forming a parabola or conical reflective mirrored surface. In one embodiment, one or more of the mirror elements 120 are fixed relative to the body face but are adaptable so as to alter optical characteristics such as focal length.

The body mast 170 is attached or secured to the stabilizing base 174, which in turn is attached or secured to rover 176, the rover able to translate or move or apply a locomotive force to change position. The body 110 is secured or positioned relative to the stabilizing base at an elevation distance 172. In some embodiments, the elevation distance 172 may be adjustable through means known to those skilled in the art, such as by a telescoping mast that is extendable so as to raise or lower the elevation distance 172. In some embodiments, the mast is an unrolling member which is rigid following deployment. In some embodiments, the mast is an inflatable rigidizable (meaning may become rigid) textile.

The body mast 170 may be configured in any of several embodiments comprising various features. The body mast 170 may be any masted structure that provides a vertical support structure for the tracking LAMA components so as to raise the components above the ground surface and allow rotation of the array to track the movement of the Sun. In one embodiment, the body mast 170 comprises an inflatable and/or rigidizable vertical mast. In one embodiment, the body mast 170 utilizes aspects of U.S. Pat. No. 9,561,843 by Bright et al issued Feb. 7, 2017, incorporated by reference in entirety for all purposes. In one embodiment, the body mast 170 utilizes guy wires, shrouds, or spreaders which, among other things, increases stability of the vertical support structure. In one embodiment, the tracking LAMA is mounted on a carriage which moves up the body mast 170. (The rigidizable vertical support may be deployed and then a carriage upon which the LAMA array is mounted may be raised into position at the top of the vertical support. This carriage simply traverses the longitudinal length of the vertical support to raise the array). In one embodiment, the body mast 170 is an unrollable mast, and may come in the form of slit tube booms, living hinge booms, collapsible tubular masts, trussed collapsible tubular masts. (See, e.g., commercially available products from Opterus, such as those described at https://www.opterusrd.com/products.)

In one embodiment, the tracking LAMA is mounted on a carriage (the tracking LAMA starts off at base of the mast, the mast is unrolled into position, then a carriage upon which the LAMA array is mounted traverses the vertical mast to raise LAMA into position). In one embodiment, the tracking LAMA is mounted on the end and raised into position through unrolling of the mast (the tracking LAMA is deployed at the same time that the mast is unrolled into its vertical deployed configuration).

In one embodiment, the body mast 170 is a telescoping structure (the tracking LAMA is mounted on the top of the telescoping structure and raised into position). In one embodiment, the body mast 170 is a hinged structure at base, raised into position (a straight mast is rotated about a base pivot until it is vertical. The tracking LAMA is raised into position at the same time and is located at the top of the mast.)

The stabilizing base 174 ensures that the mast remains vertical in several conditions, to include: i) on initial deployment, ii) between multiple deployments, iii) actively as the tracking LAMA is being operated, and iv) actively as the tracking LAMA is being locomoted.

The input light pattern 10 may be provided by the Sun. The input light pattern 10 is received by the set of mirror elements 120 of the mirror array 121 and is reflected and altered in direction and character to form a set of mirror element output light patterns 128. Each of the set of mirror element output light patterns 128 are directed or reflected to the common spot location 180, the common spot location may be tracked and thus move, such as to common spot location 180′. The common spot location 180 or 180′ is irradiated by the set of mirror element output light patterns 128.

One or more body sensors 119 may be coupled to or attached to the body 110 and/or the body face 112. A body sensor 119 may measure one or more of: incoming solar irradiance, solar source location, target (aka the common spot location) temperature, and focal spot shape. In one embodiment, a body sensor measures the true rotation of each mirror element relative to the body face.

A common spot location sensor 189 may be located adjacent or near the common spot location to measure one or more of: target (aka the common spot location) temperature and focal spot shape.

Each adaptive mirror element 120 may be of any of several configurations or design, to include e.g., flat or concave for producing primary solar concentration. In some embodiments, the adaptive mirror elements have a spherical or parabolic shape with a far focal point many meters in distance. The mirror elements may be made from either rigid, thin-film, or inflatable materials.

The processor 160 and/or controller 162 operate to control the set of mirror orientation actuators 140, the set of mirror focal length actuators, the body actuator 164, the body sensor 119, and the common spot location sensor 189.

The processor 160 and/or controller may be configured to control and/or monitor system aspects of the tracking lunar articulating mirror array system, to include, e.g., incoming solar irradiance, solar source location, target temperature, and focal spot shape.

The processor 160 and/or controller 162 may operate to, e.g., adjust mirror element orientation to vary the target location of the solar concentrator, adjust or operate adaptive optics, control the orientation of each adaptive mirror element to produce a controllable solar flux density spot profile at the target location, rotate the mirror array about the longitudinal axis of mast or vertical tower to roughly track motion of the Sun, rotate the mirror array about a horizontal axis of mast or vertical tower to reduce cosine losses for receiver targets near the base of the array, employ the mirror array to perform selective melting of the target surface, control the irradiation or multiple spot locations simultaneously or in sequence, and employ the mirror array to perform selective liquid phase sintering of the target surface.

In the case of multiple tracking lunar articulating mirror array systems (see, e.g., FIGS. 3-4), the processor 160 and/or controller 162 may operate in a host or primary mode to control or direct the operations of client or secondary tracking systems.

The common spot location 180 or 180′ aka the irradiating location is the location at which irradiation of any working material occurs. The irradiation or more generally the concentrated energy focused on the location may be used for a variety of purposes.

In one embodiment, the actuation of the orientation of the mirror elements is by way of the motorized cam configuration (aka a cam-style two-axis actuation with one pivot point) of U.S. Pat Appl No. 63/526,914, as cited above.

In another embodiment of actuation of the orientation of the mirror elements, a thermal actuator is employed, such as a paraffin wax actuator.

In another embodiment of actuation of the orientation of the mirror elements, a screw actuator is employed, the screw actuator replacing the cam and/or wax actuator of other embodiments.

Feedback and control of the positioning aka orientation, and focal length, of each adaptive mirror element is critical. Due to the long focal distances and variable ranges of operation, such control may come from a closed loop system. Machine vision may be employed to study the flux density distribution of the combined concentrated solar spot to converge, diverge, or otherwise control positioning of individual mirror elements. Several control schemes may be used to allow more precise positioning of the mirror elements and the overall configuration of the array. Feedback may alternatively or additionally be employed at the intended spot location such as in the cases of the powering of a fixed reactor. Position sensing of the mirror elements may also be employed at or near the system to monitor relative rotation of each mirror element relative to the body face, sun position, and common spot location.

Many possible feedback and control methods for both adjusting the focal distance of individual adaptive optic mirror elements, spot location of each mirror element, combined spot position of the array, and the solar flux density distribution of the array to fit more favorable spot profiles. These include open loop and closed loop controls.

A CCD camera or other feedback device may be used to image the array itself to align the mirrors. Laser calibration devices may be employed at the tracking LAMA array or by a calibration device spaced at the target or at a separate location to confirm the intended orientation of the individual mirror elements.

Alternatively, the orientation of each mirror element can be monitored from the backside of the array via motion capture by a CCD.

In some embodiments, the control of adaptive mirror elements of the tracking LAMA may include:
Motion capture measuring state space of mirror orientations
   Camera pointed at the mirror elements themselves to determine precise rotation of each mirror element and then calculate location of each reflected spot based on current sun position and array orientation.
Procedural alignment (diverged spots then recombining)
   A calibration procedure in which the mirror element spots are diverged to isolate each one and identify which spot belongs to which mirror element. Once identified, the spots are again converged inwards to form a combined spot for the array.
Laser positioning
   Pointing a laser at the intended array spot location and converge all mirror spots at this location. Does not require a known ground topology.
Camera at the target
   A camera may be placed at the intended spot location in the cases of a fixed concentrator target and an assistive robot receiver
Frequency of twitching of each element
   Each mirror element may be moved back and forth at a given frequency to determine which spot belongs to which mirror element.
Mapping of the ground surface
   For closed-loop control the topology of the ground surface or structure may be mapped.
Band stop filters on the mirrors
   A unique optical filter may be applied to each mirror element to exclude a certain frequency of light unique for each concentrated spot. A spectral analysis may be performed on the individual spots to identify which spot belongs to which mirror element.
Process monitoring: Melt pool emissions, computer vision of melt pool, thermal profile
   The sintering or melting process may be monitored to improve the process. This includes temperature, phase change, emissions, geometry of the melt pool, etc.

Additional feedback may be added to monitor the thermochemical process being powered by the tracking LAMA. This may include temperature, temperature distribution, temperature history, liberated gases, and determination of material phase of the heated target.

The tracking LAMA may be used to produce a highly concentrated spot on the surface of regolith and translate this spot across the surface at different scan speeds and hatch spacings to produce selectively sintered and melted regolith structures across the surface of the regolith bin. Multiple control strategies may be employed to produce a highly concentrated single spot, a user-specified spot profile such as a spot with an outer ring which is more concentrated than its center, and multiple spots operating independently across the regolith surface. Feedback methods may be used for calibrating the pointing orientation of each mirror element which may include periodic recalibration of the mirrors by diverging the spots to a ring of discrete spots to identify which spot correlates to which mirror element, by a function for minimizing the size of the spot as observed by a CCD camera mounted on the prototype, or by direct monitoring of mirror orientation relative to the body face and common spot location.

The tracking LAMA system as shown in FIG. 1 is composed of an array of independently actuated parabolic mirrors which concentrate and redirect sunlight onto the ground surface. The primary solar concentration of each mirror element and combination of a large number of adaptable mirror elements forms a Fresnel solar reflector with selectable focal position. This unique optomechanical design enables sunlight to be concentrated and transmitted to one or more locations on a fixed surface, and then translated across this surface while maintaining very high concentration ratios, such as greater than 1 W/mm². These high solar concentration ratios are capable of inducing liquid-phase sintering of lunar highlands regolith at scan speeds exceeding 5 mm/s. Large areas of ground may therefore be treated with this method to produce a thin cohesive structure which entrains dust within a stabilized surface, thereby reducing dust that is lofted due to plume-surface interactions or electrostatic levitation. At slower scan speeds of, e.g., below 1 mm/s, the high solar concentration ratios which are produced by the tracking LAMA system produce a molten pool of regolith which forms higher-strength glass-ceramic structures once cooled.

Methods of feedback and control for adjusting the orientation of each mirror element include: 1) open loop control considering concentrator orientation, sun position, and topological data of the construction site, 2) closed loop control utilizing machine vision of the concentrated solar spot to minimize area of the convergent spot produced by the array or to produce a desired spot profile such as an annular ring, and 3) closed loop control utilizing motion capture to determine true rotation of each mirror element relative to the body face and the common spot location. Also, in situ process monitoring of the temperature, phase, and emissions from the molten pool of regolith enables process verification when producing horizontal structures with the tracking LAMA system. Combined, these innovative system and methods produce a robust solar concentrator Fresnel reflector with selectable focal position for lunar surface construction, dust mitigation, and solar-thermal power beaming on the Moon.

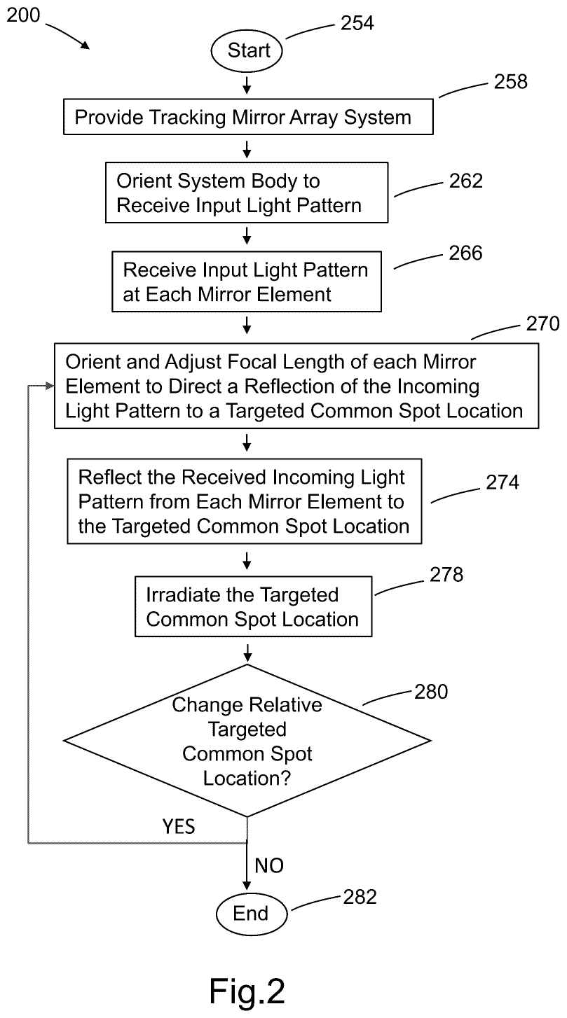

FIG. 2 is a flow chart of a method of use 200 of the tracking lunar articulating mirror array system described above, such as the embodiment of the tracking lunar articulating mirror array system of FIG. 1. Note that some steps of the method 200 may be added, deleted, and/or combined. The steps are notionally followed in increasing numerical sequence, although, in some embodiments, some steps may be omitted, some steps added, and the steps may follow other than increasing numerical order. Any of the steps, functions, and operations discussed herein can be performed continuously and automatically. The method starts at step 204 and ends at step 232.

After starting at step 254, the method 200 proceeds to step 258. At step 258, a tracking lunar articulating mirror array system is provided. The tracking lunar articulating mirror array system may be any of the embodiments described herein or combinations thereof. After completing step 258, the method 200 proceeds to step 262.

At step 262, the system body (and associated mirror array) of the tracking lunar articulating mirror array system is oriented to receive an input light pattern, such as oriented to receive an input light pattern from the Sun. In lunar polar applications, the mirror array of the tracking lunar articulating mirror array system is oriented with minimal to zero solar elevation angle. After completing step 262, the method 200 proceeds to step 266.

At step 266, the input light pattern is received at each of the mirror elements of the mirror array. After completing step 266, the method proceeds to step 270.

At step 270, the set of actuators associated with each of the set of mirror elements operates (or actuates) to orient and adjust the focal length of each adaptive mirror element to a targeted common spot location. The mirror element focal length may be adjusted or set by way of adaptive optical control. After completing step 270, the method proceeds to step 274.

At step 274, each mirror element of the mirror array reflects its respective input light pattern to the targeted common spot location, the reflected light of a mirror element output light pattern. After completing step 274, the method proceeds to step 278.

At step 278, the targeted common spot location is irradiated by the set of mirror element output light pattern of each of the mirror elements of the mirror array. After completing step 278, the method proceeds to step 280.

At step 280, a query is made to determine if the relative targeted common spot location has changed, such as may occur due to any of several reasons. For example, the mobile platform carrying the tracking mirror array system may have moved or locomoted, resulting in a change to the relative position of the targeted common spot location (and thus requiring an adjustment to the mirror elements). As another example, the tracking mirror array system may be tasked with irradiating a set of common spot locations (see, e.g., FIG. 1 and irradiation of common spot locations between 180 and 180′). If the response to the query is YES, the method 200 proceeds to step 270. If the response to the query is NO, the method proceeds to step 282 and the method 200 ends.

With attention to FIG. 3, a multiple tracking lunar articulating mirror array system 301 (the “multiple system”) is depicted, the multiple system comprising a set of two tracking lunar articulating mirror array systems 300, 300′ working in concert to irradiate a targeted common spot location 382 of an external system 380. FIG. 4 provides a method of use of the multiple tracking lunar articulating mirror array system 301 comprising the set of two tracking lunar articulating mirror array systems 300 and 300′. Each of the set of two tracking lunar articulating mirror array systems 300, 300′ are of similar type to the tracking lunar articulating mirror array system 100 of FIG. 1, yet simplified for clarity.

A first tracking lunar articulating mirror array system 300 (the “first system”) comprises a body with a body face, a set of two (operating) adaptive mirror elements 320 forming a mirror array with folded array portion with mirror 320F, the mirror array attached or coupled or engaged with the body such as the body face, a set of two mirror orientation actuators (each associated with a respective adaptive mirror element 320), a set of two mirror focal length actuators (each associated with a respective adaptive mirror element 320), a body mast 370 connected with the body, a body actuator, a stabilizing base connected with the body mast 370, a rover 376 connected with the body mast 370 and/or connected with the stabilizing base, a processor and a controller.

Each of the set of adaptive mirror elements 320 (there are two in total in the embodiment of FIG. 3) operate to receive an input light pattern 10 and reflect the input light pattern 10 to produce a mirror element output light pattern 328 (one such mirror element light pattern 328 is produced from each of the mirror elements 320). Each of the set of mirror orientation actuators (there is one mirror orientation actuator for each of the adaptive mirror elements 320), in concert with the set of mirror focal length actuators (there is one mirror focal length actuator for each of the mirror elements 320), operate to articulate the respective adaptive mirror element 320 to direct the respective mirror element light patterns 328 to the second tracking lunar articulating mirror array system 300′. (Adaptive mirror element 320F is depicted disposed on folded array portion with the folded array portion not fully unfolded and thus in an interim non-operational state; upon the folded array portion being fully unfolded, the adaptive mirror element 320F may become operational; additional components associated with the mirror element 320F are not shown for clarity, e.g., focal length actuator, orientation actuators).

Each mirror orientation actuator is configured to articulate a respective mirror element 320 about one or both of a local mirror horizontal axis (a “tilt” axis) and a normal axis relative to the mirror (a “twist” axis). The result of the “tilt and twist” configuration is a mirror element that may be oriented to project or reflect an incoming or received input light pattern to produce a mirror element light pattern 328 along a path or vector of a determined or controllable azimuth and elevation angle (such angles represented by steering arrow 329), and to thus direct that mirror element light pattern to the second tracking lunar articulating mirror array system 300′. One or more adaptive mirror elements 320 may be configured with adaptive optical control by way of the respective mirror focal length actuator, such adaptive optical control operating to control the direction, focal length, and other optical characteristics of the mirror element light pattern 328 of each mirror element 320.

A second tracking lunar articulating mirror array system 300′ (the “second system”) comprises a body with a body face, a set of two (operating) adaptive mirror elements 320′ forming a mirror array with folded array portion, the mirror array attached or coupled or engaged with the body such as the body face, a set of two mirror orientation actuators (each associated with a respective mirror element 320′), a set of two mirror focal length actuators (each associated with a respective adaptive mirror element 320′), a body mast 370′ connected with the body, a body actuator, a stabilizing base connected with the body mast 370′, a rover 376′ connected with the body mast 370′ and/or connected with the stabilizing base, a processor and a controller. Each of the set of adaptive mirror elements 320′ (there are two in total in the embodiment of FIG. 3) operate to receive an input light pattern 328 from the first tracking lunar articulating mirror array system 300 and reflect that input light pattern 328 to produce a mirror element output light pattern 328′ (one such mirror element light pattern 328′ is produced from each of the mirror elements 320′). (Adaptive mirror element 320F′ is depicted disposed on folded array portion with the folded array portion not fully unfolded and thus in an interim non-operational state; upon the folded array portion being fully unfolded, the adaptive mirror element 320F′ may become operational; additional components associated with the mirror element 320F′ are not shown for clarity, e.g., focal length actuator, orientation actuators).

Each of the set of mirror orientation actuators (there is one mirror actuator for each of the mirror elements 320′) in concert with the set of mirror focal length actuators (there is one mirror focal length actuator for each of the mirror elements 320′), operate to articulate the respective adaptive mirror element 320′ to direct the respective mirror element light patterns 328′ to the targeted common spot location 382 of an external system 380. Each adaptive mirror actuator is configured to articulate a respective mirror element 320′ about one or both of a local mirror horizontal axis (a “tilt” axis) and a normal axis relative to the mirror (a “twist” axis). The result of the “tilt and twist” configuration is an adaptive mirror element that may be oriented to project or reflect an incoming or received input light pattern to produce a mirror element light pattern 328′ along a path or vector of a determined or controllable azimuth and elevation angle (such angles represented by steering arrow 329′), and to thus direct that mirror element light pattern to the targeted common spot location 382 of an external system 380. One or more adaptive mirror elements 320′ may be configured with adaptive optical control by way of the respective mirror focal length actuator, such adaptive optical control operating to control the direction, focal length, and other optical characteristics of the mirror element light pattern 328′ of each adaptive mirror element 320′.

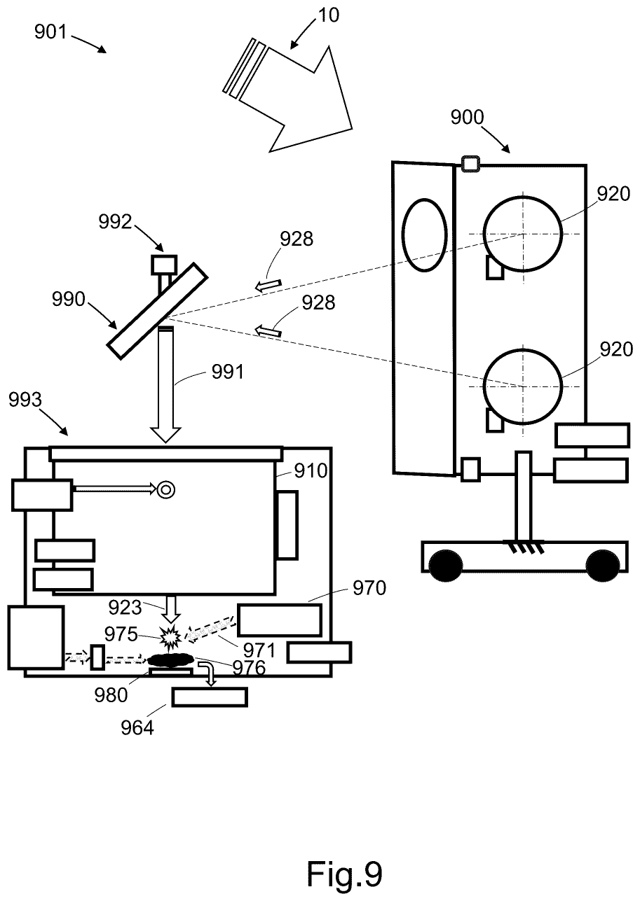

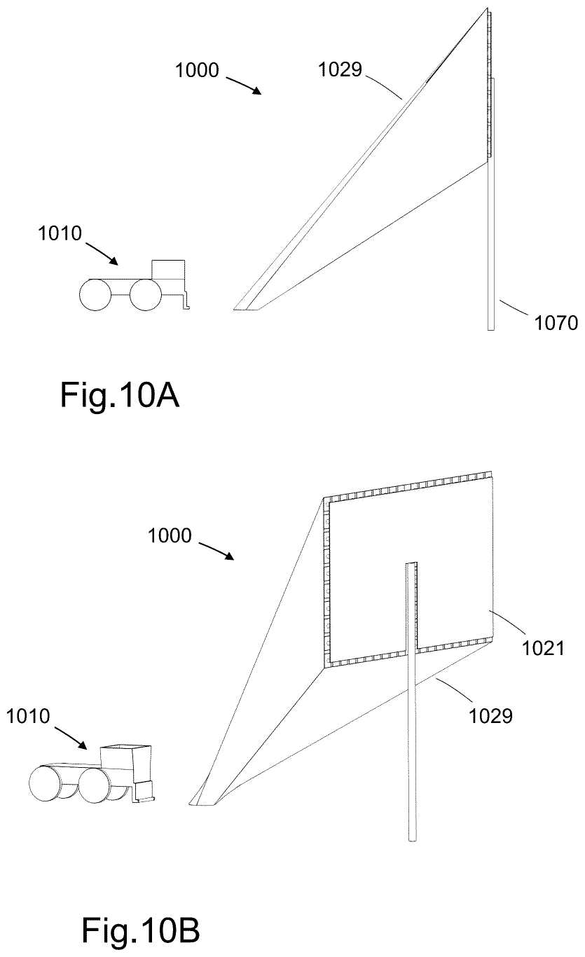

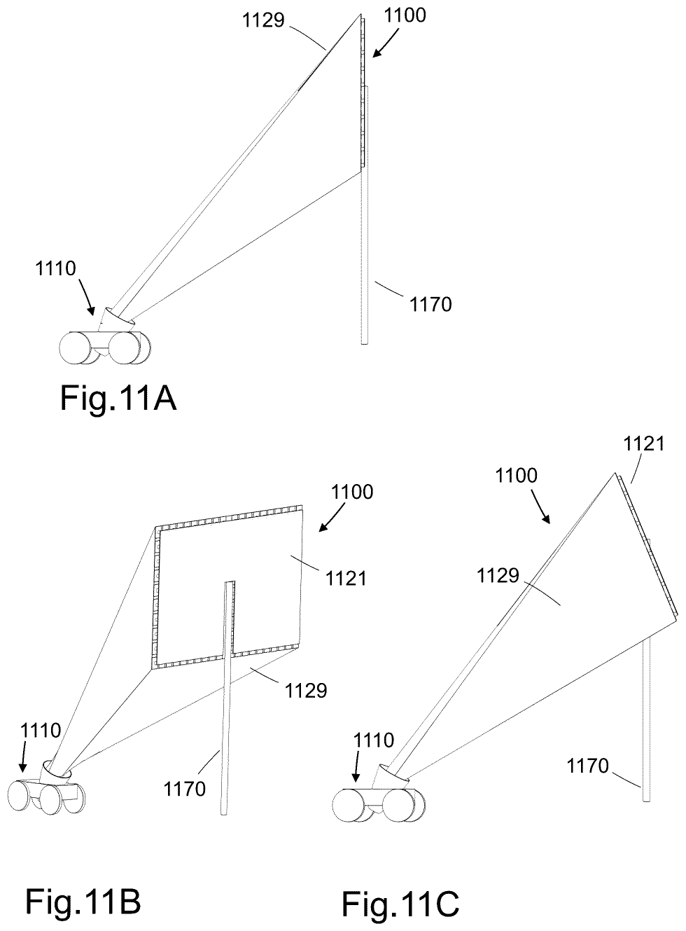

Other configurations of multiple tracking lunar articulating mirror array systems are possible, e.g., a different number of multiple tracking lunar articulating mirror array systems such as three. The set of tracking lunar articulating mirror array systems work in concert to direct light patterns between systems. One or more of the tracking lunar articulating mirror array systems may be mobile by way of respective rovers 376, 376′. One or more of the tracking lunar articulating mirror array systems may be non-mobile and mounted to a stationary structure. One or more tracking lunar articulating mirror array systems may be adapted to operate in alternate configurations, such as, e.g., engaged with a SCORCHER system to form a Lunar Refining System (see FIG. 8), engaged with a SEER system (see FIG. 9), engaged with a regolith smoothing and deposition rover (see FIGS. 10A-B), or engaged with a SEER-mounted rover (see FIGS. 11A-C).

Similar to the above description regarding the systems of FIGS. 1-2, a set of spot locations at a common or a set of locations may be irradiated simultaneously or sequentially by the system 300.

In one embodiment, one or more of the mirror elements 320 and/or 320′ are rigid and are not adaptable so as to alter optical characteristics such as focal length, but instead are of a fixed design and configuration, such as forming a parabola or conical reflective mirrored surface. In one embodiment, one or more of the mirror elements 320, 320′ are fixed relative to the body face but are adaptable so as to alter optical characteristics such as focal length.

FIG. 4 is a flow chart of a method of use 400 of the multiple tracking lunar articulating mirror array system 301 of FIG. 3. Note that some steps of the method 400 may be added, deleted, and/or combined. The steps are notionally followed in increasing numerical sequence, although, in some embodiments, some steps may be omitted, some steps added, and the steps may follow other than increasing numerical order. Any of the steps, functions, and operations discussed herein can be performed continuously and automatically. The method starts at step 404 and ends at step 448.

After starting at step 404, the method 400 proceeds to step 408. At step 408, the multiple tracking lunar articulating mirror array system 301 is provided, the multiple tracking lunar articulating mirror array system 301 comprising a first tracking lunar articulating mirror array system or first system and a second tracking lunar articulating mirror array system or second system. Each of the first system and the second system may be any of the embodiments described herein or combinations thereof. After completing step 408, the method 400 proceeds to step 410.

At step 410, a targeted common spot location for the multiple tracking lunar articulating mirror array system is identified. Such a spot may include a static spot, a dynamic spot (e.g. one that moves), and a spot as part of an external system (e.g. SEER or SCORCHER). After completing step 410, the method 400 proceeds to step 412.

At step 412, the system body (and associated mirror array) of the first system is oriented to receive an input light pattern, such as oriented to receive an input light pattern from the Sun. In lunar polar applications, the mirror array of the tracking lunar articulating mirror array system is oriented with minimal to zero solar elevation angle. After completing step 412, the method 400 proceeds to step 416.

At step 416, the input light pattern is received at each of the adaptive mirror elements of the mirror array of the first system. After completing step 416, the method proceeds to step 420.

At step 420, the set of actuators associated with each of the set of mirror elements of the first system operates (or actuates) to orient and adjust or set the focal length of each adaptive mirror element to the mirror elements of the second system. The orientation of the mirror elements of the first system may be established by way of a set of mirror orientation actuators, and the focal length of the mirror elements of the first system may be adjusted by way of adaptive optical control and a set of mirror focal length actuators. After completing step 420, the method proceeds to step 424.

At step 424, each adaptive mirror element of the mirror array of the first system reflects its respective input light pattern to the adaptive mirror elements of the second system, the reflected light of a mirror element output light pattern. After completing step 424, the method proceeds to step 428.

At step 428, the system body (and associated mirror array) of the second system is oriented to receive the input light pattern from the first system. After completing step 428, the method 400 proceeds to step 432.

At step 432, the input light pattern from the first system is received at each of the adaptive mirror elements of the mirror array of the second system. After completing step 432, the method proceeds to step 436.

At step 436, the set of mirror orientation actuators associated with each of the set of adaptive mirror elements of the second system operates (or actuates) to orient and adjust or set the focal length of each adaptive mirror element to the targeted common spot location. The orientation of the mirror elements of the second system may be established by way of a set of mirror orientation actuators, and the focal length of the mirror elements of the second system may be adjusted by way of adaptive optical control and a set of mirror focal length actuators. After completing step 436, the method proceeds to step 440.

At step 440, each mirror element of the mirror array of the second system reflects its respective input light pattern to the targeted common spot location. After completing step 440, the method proceeds to step 444.

At step 444, the targeted common spot location is irradiated. After completing step 440, the method proceeds to step 448 and the method 400 ends.

As noted above, some steps of the method 400 may be omitted, some steps added, and the steps may follow other than increasing numerical order. For example, should the targeted spot location move, either absolutely (e.g., if a traced irradiation pattern is to be followed) or relatively (e.g., one or both rovers 376, 376′ translate or move), an additional step (after step 444) would involve a query to determine if the relative targeted common spot location has changed (similar to step 280 of method 200 of FIG. 2). Such a query, if responded to affirmatively (i.e., the targeted common spot location moved), would result in a return to step 412 of the method 400. If the response was negative (i.e., the targeted spot did not move), the method 400 would proceed to step 448 and the method 400 would end.

As briefly mentioned above, in some configurations or embodiments, one or more mirror elements may be controlled through adaptive optics. In the disclosure, one or more mirror elements may be so altered to produce desired optical characteristics (such as those of a parabolic mirror) from notional optical characteristics (such as of a flat mirror). The adaptive mirror elements may provide adjustable focal length for one or more individual elements (including, e.g., circular and non-circular geometries, parabolic, spherical, offset parabolic, and other surface contours). The adaptive mirror elements may be made from, e.g., rigid, thin-film, or inflatable materials. The characterization of the irradiated targeted spot may be performed by imaging the reflected light intensity of the spot produced in the mirrors in each of an undeformed and deformed state(s).

FIGS. 5, 6, and 7A-D described mirror elements that comprise and enable adaptive optical features and means to achieve such features.

With attention to FIG. 5, a point-pull embodiment of an adaptive mirror element is provided. Generally, the mirror element is elastically deformed by applying a point load at its center. A point load is applied to the center of the mirrored element to draw it into a concave geometry. The boundary condition may be modified to most closely approximate a spherical or parabolic geometry. The boundary conditions may be of a fixed configuration, a roller configuration, or a more complex configuration to achieve a more spherical or parabolic geometry of the deformed shape. Stated another way, a notional undeformed mirror is deformed or adapted through elastic deformation to form an alternate shape, such as a parabolic (mirror) shape.

FIG. 5 depicts adaptive mirror element 520 comprising two opposing plates 521, 522 fitting within a respective ring 523, 524, the two rings 523, 524 disposed on opposing sides of a separation ring 525. The upper or outward facing plate 521 is mirrored and is positioned to face a spot location target in a larger targeted lunar articulating mirror array system. A threaded adjustment bolt or screw (not shown) operating in a threaded hole 527 or with a nut in the back or lower plate 522 is then used to shorten the path between the plates 521, 522 and apply a point load on the mirrored plate 521 to deform it into a concentrating geometry, such as a parabolic shape.

Note that a thin-film reflector may serve as a lightweight mirror element. Materials may include mylar, silver, or other very thin reflective films. In one point-pull embodiment of an adaptive mirror element, a mylar sheet serves as the mirrored plate 521 and has a small connection affixed to its center where a load is applied (to alter the notional shape of the mylar sheet). The outer assembly has a rigid supporting hoop that secures the upper or facing plate (the mylar sheet) of the mirror element. Alternately, a glass substrate with mirrored surface may serve as a lightweight mirror element; either first surface or second surface mirrors may be used. Furthermore, a thin metal reflector (such as polished aluminum or silver) may serve as a lightweight mirror element.

With attention to FIG. 6, an annular push embodiment of an adaptive mirror element is provided. Generally, a (mirror deforming) load is applied onto a very rigid backer plate. This load is transferred to an annular ring to apply a force at the outside ring of the mirrored element. A ring inset on the mirror element provides a counter-opposing force that then deforms the mirror into a parabolic geometry.

One such mirror element embodiment is provided by U.S. Pat. No 7,229,178 to Headley et al, issued Jun. 12, 2007, hereby incorporated by reference in entirety for all purposes. An axial linear actuator is mounted in the center of a circular flange that is affixed to a hollow cylindrical housing. The housing has a central bore that allows light to enter and reflect off a mirrored surface. An actuator pushes on backside of a disk which in turn pushes on a backside of a piston plate that in turn pushes on a backside of a mirrored plate. An outer ring on a piston plate pushes onto the backside of the mirrored plate that is pushed back on by an inner retaining ring, creating a concave parabolic mirror.

With attention to FIG. 6, an inner threaded ring annular push adaptive mirror element 620 is disclosed. A housing 633 has a central bore that allows light to enter and reflect off mirrored surface S of backside of mirror plate 615, similar to the housing and mirrored surface of the backside of the mirrored plate described immediately above. However, the embodiment of FIG. 6 with mirror element 620 employs a threaded piston ring 636 configured to engage inner threads of the housing 633. Thus, instead of using the rigid backer plate disk of a mirror element described immediately above, the inner surface of the hollow cylindrical housing 633 of mirror element 620 engages with a threaded piston ring 636. Upon rotation of the threaded piston ring 636, the threaded piston ring 636 applies a force onto the backside of mirror plate 615 and creates a concave parabolic mirror S. The threaded piston ring 636 may be rotated by any of several means known to those skilled in the art, to include a handle extension from the threaded piston ring 636, rotational motor, etc., as known to those skilled in the art. In one embodiment of the inner threaded ring annular push adaptive mirror element 620, the backside of mirror plate 615 is pushed back on by an inner retaining ring. Advantages of the inner threaded ring annular push adaptive mirror element 620 over conventional mirror element embodiments (to include the embodiment described immediately above) include decreased weight and increased reliability, robustness, and manufacturability due to a reduced part count and simpler design.

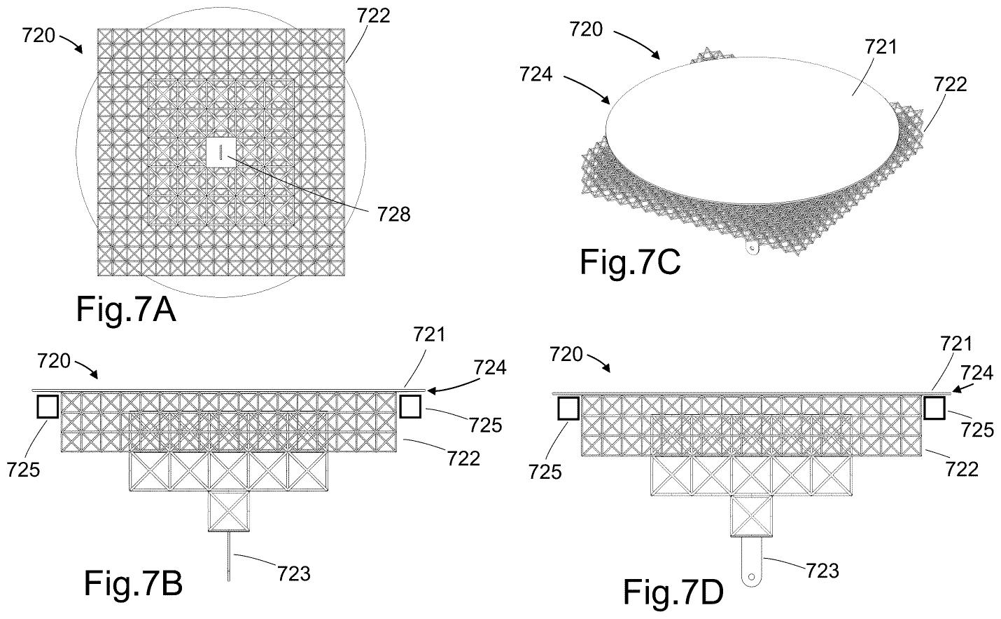

FIGS. 7A-D are a set of views of another embodiment of an adaptive mirror element. Generally, the point-pull design discussed above may be applied with use of functionally graded material. Stated another way, the point-pull method of operating or controlling an adaptive mirror element may use various geometries/materials applied to the back surface of a mirror to obtain a more parabolic geometry once deformed. The various geometries/materials may come in the form of 3D printed structures determined through topology optimization or laminated sheets of different thickness/materials. (The phrases “3D printed,” “3D printing,” and “additive manufacturing” mean the process of manufacturing objects from 3-dimensional model data through the repeated addition of small amounts of material, usually layer upon layer). An objective of such adaptive mirror element designs is to reduce mass of the assembly while enabling a close approximation to a parabola shape for the mirror deformed through a single application of load applied onto the back of the mirror element/backer component.

With attention to FIGS. 7A-D, an adaptive mirror element 720 is depicted. The adaptive mirror element 720 comprises mirror outer surface 721 (this surface receives and reflects light) of a mirror plate 724, adjustment mechanism 728, lattice structure 722, actuator arm 723, and reaction plate 725. The actuator arm 723 translates or moves up and down to impart a force by way of adjustment mechanism 728 onto the lattice structure 722, the lattice structure 722 in turn actuating or moving upwards to varying distances (toward the mirror outer surface 721) in such a manner to create a parabolic shape (or other shape) for the mirror outer surface 721. Stated another way, the actuator arm 723 operates as a point-push toward the mirror 721 such that as the actuator pushes toward the mirror plate 724, the lattice structure reacts to impart a set of forces to the underside of the mirror plate 724 such that a parabolic shape is created on the mirror outer surface 721. A reaction plate 725 is inserted or is disposed below or adjacent the opposite side of the mirror outer surface 721 to enable a particular shape of mirror element upon actuation of the actuator arm 723 and/or adjustment mechanism 728. The reaction plate 725 may engage all or part of the mirror plate 724 on the side opposite the mirror outer surface 721. (Note that the adjustment mechanism 728 may be any mechanism that enables or facilitates the translation or up and down movement of the mirror outer surface 721, to include a threaded bolt configuration similar to that described in FIG. 5, for example).

The mirror array portion of the tracking LAMA may employ a folding portion (see element 122 of FIG. 1) and various configurations to fold all or a portion of the mirror array. The embodiments comprising a mirror array that may fold include: i) a tri-fold array structure (similar to the packaging/deployment of the array of the James Webb space telescope), ii) an accordion style unfolding from the top down (the tracking LAMA is packaged as a series of horizontal sections which are folded into an accordion-style packaged configuration—once the tracking LAMA is at the top of the mast structure the horizontal sections are allowed to unfold into the planar configuration of mirror elements), iii) an accordion style unfolding from bottom up during deployment of the tracking LAMA, iv) an origami unfolding (mirrors initially facing inwards), and v) other arrangements known to those skilled in the art, to include more complex stowed configurations.

As described above with respect to FIGS. 3-4, a set of tracking lunar articulating mirror array systems may be configured to provide solar power to a central unit (i.e. SCORCHER). Also, a set of tracking lunar articulating mirror array systems may incorporate multiple reflections between two or more lunar articulating mirror array systems (i.e. one LAMA beams power to a second LAMA which then beams this power to the central unit). Inactive lunar articulating mirror array systems positioned between the Sun and active LAMAs may be turned sideways relative to the Sun to minimize shadowing.

In one embodiment, a tracking lunar articulating mirror array system may be used to power a fixed lunar surface asset such as an oxygen production plant. To power the plant through the entire night-day cycle, multiple tracking LAMAs may be positioned around the plant to be active or inactive depending on location of the Sun. Additional power may be provided to the plant by using multiple tracking LAMAs reflecting light to the plant location and even tracking LAMAs reflecting light onto other tracking LAMAs which is then reflected to the plant location.

In one embodiment, the tracking LAMA may be used to power extractive metallurgical processes for refining lunar regolith into high-purity products including silica, alumina, iron, and oxygen, and for generating useful byproducts from the waste slag. Such an embodiment may form a Lunar Refining System (LRS), as depicted in FIG. 8.

The LRS as shown in FIG. 8 is targeted towards massive scalability and bulk processing of minimally beneficiated lunar regolith to economically extract multiple refined product streams while deriving secondary uses from the process waste. The LRS may incorporate a lightweight and scalable primary solar collector, a secondary solar concentrator, and a beam-down concentrated solar reactor for heating regolith in a continuous process to very high temperatures (>1,600° C.) in order to extract gaseous oxygen and mineral product streams. A gas handling system is then used to collect these extracted gases for their ultimate sale to lunar and in-space customers. This LRS takes advantage of the unique conditions at the lunar south pole to efficiently extract and refine products from bulk regolith requiring minimal beneficiation. Lightweight reflective optics are used to collect and concentrate sunlight and a free-space optical design is used to beam highly concentrated sunlight (>1,000× concentration ratio) into a high efficiency concentrated solar reactor without the need for heavy transmission optics which are prone to overheating and failure. A reflective secondary solar concentrator is then used to further concentrate the beamed solar power by 4× or more times while tailoring the output solar flux density distribution relative to the regolith particle path for increasing solar-to-thermal efficiencies when heating regolith to temperatures greater than 1,600° C. Solar-thermal power then drives extractive metallurgical processes used to facilitate thermal decomposition of metallic oxides within lunar regolith to separate oxygen and mineral gaseous products.

With attention to FIG. 8, a system 801 comprising a tracking lunar articulating mirror array system 800 operating in concert with a Solar Concentrating Oxygen Reactor for Continuous Heating and Extrusion of Regolith (SCORCHER) system 210 is depicted.

The tracking lunar articulating mirror array system 800 is similar to that described in FIG. 1 and is shown receiving an input light pattern 10 at each of two adaptive mirror elements 820 which reflect the input light pattern 10 to produce a respective mirror element output light pattern 828 (one such mirror element light pattern 828 is produced from each of the adaptive mirror elements 820). The set of mirror element light patterns 828 are received by and reflected from redirecting mirror 890 to produce a redirected light pattern 891. The redirected light pattern 891 is in turn provided as input to the Solar Concentrating Oxygen Reactor for Continuous Heating and Extrusion of Regolith (SCORCHER) system 210 where, among other things, regolith is processed. Other regolith processing systems may be so engaged.

The SCORCHER embodiment of FIG. 8 is that of the U.S. Patent Ser. No. 17/668,206 to Brewer et al (cited above). Generally, a thermochemical reaction occurs at the defined irradiating location 260 within an enclosed vessel volume 212 when the set of falling particles 232 are irradiated by the redirected light pattern 891. The thermochemical reaction yields or produces a molten reacted material and a second gas 214. The molten reacted material is collected or gathers as a molten reacted material pool (aka a molten slag pool or slag pool) 233 which in turn is fed into a slag extrusion nozzle 242. A layer of insulation 213 is disposed at the bottom of the clear reactor shell 211. The layer of insulation 213 may consist of non-reacted particles from the particle feed 232 to form a skull through which the molten reacted material 233 is allowed to flow. The gas inlet 215 receives a first gas as a first gas input stream 217 from a source external to the enclosed vessel volume 212. The first gas input stream 217 is coupled to or in fluid communication with gas inlet 215. The gas inlet 215 receives first gas input stream 217 and provides or supplies a first gas output stream 219 to the enclosed vessel volume 212. The first gas output stream 219 is coupled or in fluid communication with gas inlet 215. The gas outlet 216 receives a second gas as a second gas input stream 214 from the enclosed vessel volume 212 and outputs or emits a second gas output stream 218 to a source or location external to the enclosed vessel volume 212. The second gas input stream 214 is coupled to or in fluid communication with gas outlet 216. The gas outlet 216 receives second gas input stream 214 from the enclosed vessel volume 212 and provides or supplies a second gas output stream 218 to an external source. The second gas output stream 218 is coupled to or in fluid communication with gas outlet 216.

With attention to FIG. 9, a system 901 comprising a tracking lunar articulating mirror array system 900 operating in concert with a Sintering End Effector for Regolith (“SEER”) system 993 is depicted.

The tracking lunar articulating mirror array system 900 is similar to that described in FIG. 1 and is shown receiving an input light pattern 10 at each of two adaptive mirror elements 920 which reflect the input light pattern 10 to produce a respective mirror element output light pattern 928 (one such mirror element light pattern 928 is produced from each of the adaptive mirror elements 920). The set of mirror element light patterns 928 are received by and reflected from redirecting mirror 990 to produce a redirected light pattern 991. The redirected light pattern 991 is in turn provided as input to the SEER system 993 where, among other things, the precise and controlled heating, sintering, and/or phase change of particles is performed. Other particle processing systems may be so engaged.

The SEER embodiment of FIG. 9 is that of U.S. Patent Ser. No. 17/983,266 to Brewer (cited above). Generally, the SEER system 993 receives the redirected light pattern 991 and uses that light to irradiate a working (aka receiver) material (such as regolith particles) to yield or produce a reacted material. A supplemental concentrator 910 receives the redirected light pattern 991 and outputs a supplemental concentrator light pattern 923, the supplemental concentrator 910 comprising reflective optics. The supplemental concentrator output light pattern 923 is typically more concentrated, narrower, more focused, and/or of a reduced light profile relative to the input redirected light pattern 991. A working material feed 970 operates to deliver a working material stream 971 to an irradiating location 975. In some embodiments the working material stream is a stream of particles such as regolith particles. The supplemental concentrator output light pattern 923 irradiates the working material stream at the irradiating location 975 to create a feedstock melt pool 976, yield a reacted material, and/or irradiate a material on a print bed surface 980. In one embodiment, reacted material is a molten reacted material. A gas collector 964 collects gases emitted during the irradiation of the working material aka receiver material, such as any gas produced from a molten reacted material.

The redirecting mirror 990 comprises a process monitoring device 992, such as a camera, which enables direct viewing of the SEER 993 and operations within the SEER 993. For example, the process monitoring device 992 may allow viewing of the feedstock melt pool 976 and/or the print bed surface 980. More generally, the view provided by the process monitoring device 992 enables, for example, 1) spot positioning adjustments for the tracking LAMA to center the spot on the SEER inlet, 2) process monitoring of the melt pool formation and geometry of the melt pool below SEER, and 3) temperature monitoring of the heated surface.

FIGS. 10A-B depict a tracking lunar articulating mirror array system 1000 as assisted by a regolith smoothing and deposition rover 1010. The tracking lunar articulating mirror array system 1000 comprises mirror array 1021 as mounted on body mast 1070, the mirror array 1021 producing mirror element output light pattern 1029. In one embodiment, the rover 1010 may engage with the tracking LAMA 1000 for powering photovoltaics and providing supplemental heating in shadowed areas.

FIGS. 11A-C depict a tracking lunar articulating mirror array system 1100 as engaged with a SEER rover 1110 (a SEER mounted within a rover) which traverses across the ground or structure surface. The tracking lunar articulating mirror array system 1100 comprises mirror array 1121 as mounted on body mast 1170, the mirror array 1121 producing mirror element output light pattern 1129. This SEER rover 1110 may both deposit and melt regolith. The rover 1110 may also traverse atop a structure under construction to enable vertical constructions such as habitats, etc.

In one embodiment, a SEER robotic end effector is engaged with a tracking lunar articulating mirror array system (a robotic arm holding a SEER at its end). The robotic arm moves SEER across the surface being melted and the tracking lunar articulating mirror array system tracks the inlet of the SEER to provide it continuous power.

Note that other methods of use of the disclosed lunar articulating mirror array system are possible. Also, any of the steps, functions, and operations discussed herein can be performed continuously and automatically. In some embodiments, one or more of the steps of the method of use may comprise computer control, use of computer processors, and/or some level of automation.

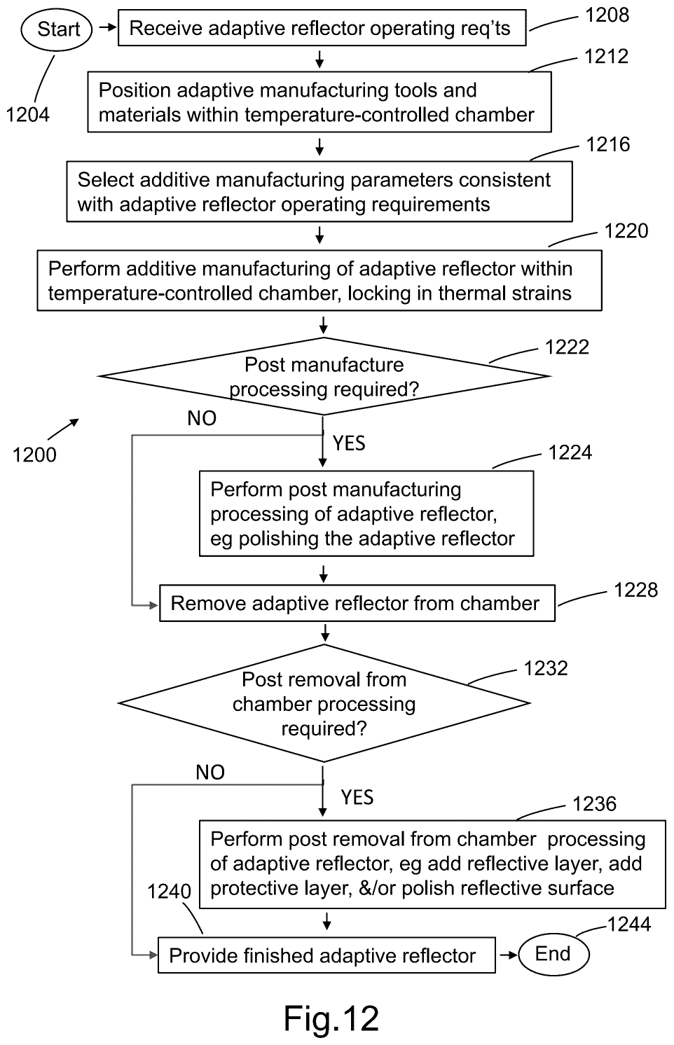

FIGS. 12-18C describe aspects of variable focal length optical systems, in particular bimetallic curved mirror variable focal length optical systems and annular force controlled concentrating reflector variable focal length optical systems. The variable focal length optical systems operate to produce concentrated light at a selectable focal length. The selectable focal length may be dynamically adjusted or controlled.

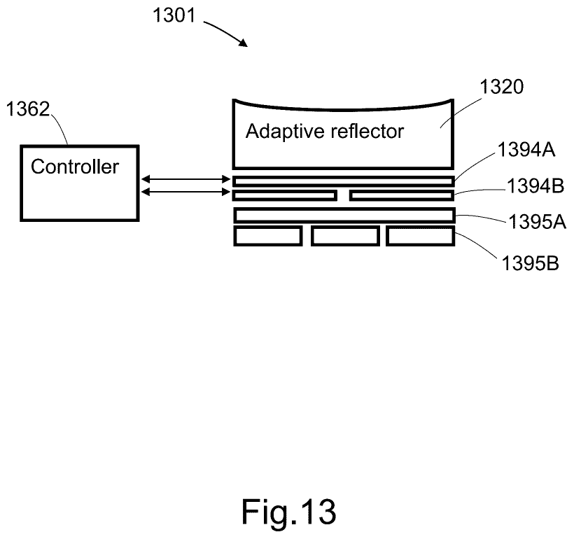

With attention to FIGS. 12 and 13, a respective method of manufacture of a thermally controlled adaptive reflector and a system that employs a thermally controlled adaptive reflector are described. Generally, the thermally controlled adaptive reflector is made of a substrate material coupled or attached or joined to a front surface material, each with different thermal expansion properties (e.g., each with different coefficients of thermal expansion aka thermal expansion coefficients). When thermal energy (e.g., heat) is applied to the two joined materials, the difference in thermal expansion properties results in a curved combined or joined material. The curve may result in a parabolic or other shape on one surface of the combined material. The front surface side of the joined material may be used as an optical reflector or optical mirror of a defined sagitta and focal length. The term “sagitta” or “sag” means a measure of the maximum distance in height across a curved surface. The degree or amount or value of sagitta, or the related focal length, of the formed optical (front surface) side of the adaptive reflector may be controlled by the degree of thermal energy applied to the adaptive reflector, with an decrease in sagitta occurring with an increase in heat energy applied.

Note that the temperature controlled manufacturing chamber locks in thermal strains during manufacturing of a bimetallic flat plate such that when the plate is removed from this temperature controlled environment, it curves to form a parabolic or near-parabolic shape. The material types and thicknesses, along with the temperature of the ultrasonic additive manufacturing chamber, may be tailored to achieve a desired focal length for the mirror at the operating temperature in the working environment. Heaters and/or coolers may then be used to make minor modifications to the mirror shape without expending significant amounts of power doing so. Multi-layer insulation may be applied to the backside of the mirror to further reduce energy demands by these heaters/coolers.

For bimetallic curved mirror embodiments of adaptive reflectors produced via temperature controlled manufacturing, heating or cooling is applied to a mirror to induce controlled bending of the mirror. The simplest form of this reflector is a bimetallic disc composed of two dissimilar metals bonded together to form a flat plate. Heating or cooling causes bending of the disc due to differential thermal expansion between the two materials which each have a distinctive coefficient of thermal expansion. This differential thermal expansion produces a spherical, parabolic, or near-parabolic curvature if the mirror is left unconstrained.

Bimetallic discs are frequently used in electrical circuits and temperature sensors to deform as their temperature changes.

Generally, in the additive manufacturing process, a substrate is first deposited on the build surface via ultrasonic welding, with this substrate material generally having a low coefficient of thermal expansion such as silicon, titanium, molybdenum, tungsten, etc. Once the substrate has been built up to the desired thickness through ultrasonic additive/subtractive manufacturing, a dissimilar metal is bonded to the substrate via ultrasonic additive manufacturing. This dissimilar metal is one which has high reflectivity and generally high coefficient of thermal expansion, such as silver or aluminum. The reflective surface may be polished after initial manufacturing if needed, however the metallic foils that are used in ultrasonic additive/subtractive manufacturing may be able to maintain a high reflectance without additional polishing. A thin reflective layer may alternately be deposited onto the front surface via physical vapor deposition or similar process. A protective layer may be deposited on the reflective surface to avoid oxidation and to protect the reflective surface from wear and minor damage. More than two layers may be used in the ultrasonic additive/subtractive manufacturing method to achieve different desired mechanical, thermal, or optical properties.

The temperature of the workpiece is maintained throughout the manufacturing process to a set temperature which is determined based on the expected steady-state temperature of the reflector in its final operating environment and the desired baseline focal length of the mirror. For example, when operating at low temperatures in space, the reflector is manufactured at an elevated chamber temperature such that thermal strains are induced in the reflector once deployed in space as caused by more thermal contraction of the high coefficient of thermal expansion front surface mirror material than the low coefficient of thermal expansion substrate such that the reflector takes on a parabolic shape and concentrates light by the high reflectance material. Supplemental heating or cooling of the variable focal length adaptive optic can then be made to cause an increase in the focal length or a decrease of the focal length, respectively.

With attention to FIG. 12, a flow chart of one embodiment of a method of manufacture of a thermally controlled adaptive reflector, of the type shown in FIG. 13, is described.

Note that some steps of the method 1200 may be added, deleted, and/or combined. The steps are notionally followed in increasing numerical sequence, although, in some embodiments, some steps may be omitted, some steps added, and the steps may follow other than increasing numerical order. Any of the steps, functions, and operations discussed herein can be performed continuously and automatically. The method starts at step 1204 and ends at step 1244.

After starting at step 1204, the method 1200 proceeds to step 1208. At step 1208, the system receives operating requirements for the adaptive reflector. Such requirements may include a targeted focal length at a targeted operating (environment) temperature, a minimal focal length at a given operating temperature, and a maximum focal length at given operating temperature. A table of min/max focal lengths for a range of operating temperatures may also be provided. Other parameters may be provided that serve to define the configuration of the adaptive reflector, e.g., external boundary conditions and loads may be defined. A notional or baseline focal length at a specified operating temperature/environment may also be provided. Note that typically the targeted operating environment will be different than the notional or baseline operating temperature/environment. For example, the targeted operating environment may be in space (a very low pressure, low temperature operating environment), and the baseline operating environment may be on Earth at 1 atmosphere pressure at specific temperature typical within a payload area of a rocket. After completing step 1208, the method 1200 proceeds to step 1212.

At step 1212, a set of adaptive manufacturing tools, such as those used in ultrasonic additive manufacturing (UAM), and materials (such as a substrate and a front surface material), are positioned within a temperature-controlled chamber. The phrase “ultrasonic additive manufacturing” means manufacturing through the building up of solid objects through ultrasonically welding successive layers of material into a three-dimensional shape, with periodic machining operations to create any detailed features of the resultant object. After completing step 1212, the method 1200 proceeds to step 1216.

At step 1216, manufacturing parameters (such as, e.g., thickness of each of the front surface material and the substrate) are selected or established that are consistent with or will produce the adaptive reflector to the adaptive reflector operating requirements. After completing step 1216, the method 1200 proceeds to step 1220.

At step 1220, additive manufacturing is performed within the temperature-controlled chamber using the selected set of materials and selected set of additive manufacturing tools. In one embodiment, aspects of UAM as described in U.S. Pat. No. 9,446,475 entitled “Weld Assembly for Ultrasonic Additive Manufacturing Applications” to Norfolk are employed; U.S. Pat. No. 9,446,475 is incorporated by reference in entirety for all purposes. A set of thermal strains are secured in the adaptive reflector. After completing step 1220, the method 1200 proceeds to step 1222.

At step 1222, a query is made to determine if any post manufacturing processing is required while the adaptive reflector is still positioned within the temperature-controlled chamber. If the response in NO, the method proceeds to step 1228. If the response is YES, the method 1200 proceeds to step 1224.

At step 1224, required post manufacturing processing of the adaptive reflector is performed inside the temperature-controlled chamber, such as polishing the adaptive reflector. Such polishing, e.g., may be more readily performed while the adaptive reflector is positioned as a flat surface within the chamber. After completing step 1224, the method 1200 proceeds to step 1228.

At step 1228, the adaptive reflector, as produced through adaptive manufacturing within the temperature-controlled chamber, is removed from the temperature-controlled chamber. After completing step 1228, the method 1200 proceeds to step 1232.

At step 1232, a query is made to determine if any post manufacturing processing is required outside of the temperature-controlled chamber, i.e., after the adaptive reflector has been removed from the chamber. If the response in NO, the method proceeds to step 1240. If the response is YES, the method 1200 proceeds to step 1236.

At step 1236, required post manufacturing processing of the adaptive reflector outside of the temperature-controlled chamber is performed, such as adding a reflective layer, polishing the reflective surface, adding a thin reflective surface, and/or adding a protective layer to the reflective surface. After completing step 1236, the method 1200 proceeds to step 1240.

At step 1240, the finished adaptive reflector is provided, and may be used as part of a larger adaptive reflector system, such as described in Figure. After completing step 1240, the method 1200 proceeds to step 1244 and ends.

FIG. 13 is a schematic representation of one embodiment of the thermally controlled adaptive reflector system manufactured using the flow chart of FIG. 12.

The thermally controlled adaptive reflector system 1301 of FIG. 13 comprises an adaptive reflector body 1320, one or more thermal units 1394A, 1394B, one or more insulation layers 1395A, 1395B, and a controller 1362.

The adaptive reflector body 1320 is disposed adjacent to one or more thermal units 1394A, 1394B, which generate thermal energy that is provided to the adaptive reflector body 1320 or which remove thermal energy from the adaptive reflector body 1320 by cooling. The more thermal units 1394A, 1394B may be of various configurations as known to those skilled in the art, to include a continuous, uniform thickness as depicted by thermal unit 1394A or a discontinuous unit as depicted by thermal unit 1394B.

The controller 1362 operates, among other things, to control the thermal output or thermal energy of the thermal units 1394A, 1394B. The thermal energy provided to the adaptive reflector body 1320 by the thermal units 1394A, 1394B changes the adaptive reflector body 1320 curvature or sagitta and thus also changes its focal length. Stated another way, the adaptive reflector body 1320 may have a first sagitta with a first focal length when the adaptive reflector body 1320 is at a first temperature and, when thermal energy is provided to the adaptive reflector body 1320 or removed from the adaptive reflector body 1320, the change in thermal energy within the adaptive reflector body 1320 changes the adaptive reflector body 1320 to a second temperature and a second sagitta with a second focal length.

In one embodiment, a user may provide a targeted or selected focal length for the adaptive reflector, and the controller would control the thermal unit(s) to output thermal energy so as to effect the configuration (e.g. the varied thermal expansion of the components of the adaptive reflector) so as to achieve the targeted or selected focal length. In one embodiment, one or more thermal units is an embedded thermal unit positioned within the adaptive reflector body 1320.

One or more insulation layers 1395A, 1395B may be disposed adjacent the one or more thermal units. The insulation layers 1395A, 1395B operate to prevent the loss of or addition to at least some of the thermal energy of the thermal units 1394A, 1394B.

Supplemental heating may be supplied through direct electrical resistive heating of the substrate and/or front surface reflective material, through heaters imbedded within the reflector body which are enabled through the ultrasonic additive/subtractive manufacturing process, or through one or more heaters affixed to the substrate of the reflector body. Increased control of the shape of the reflective front surface may be achieved through the addition of multiple heaters to allow more spatially selective shape changes to the adaptive optic such as in the case of resolving aberrations and potential manufacturing defects to still achieve a near-parabolic shape. Total energy required to heat the reflector may be reduced by adding a reflective layer to the backside of the substrate and heater assembly to reduce radiative heat losses in a vacuum environment. Alternatively, sections of the multilayer insulation may be selectively removed to enable increased radiative cooling of the substrate either locally or globally across the mirror.

Multiple thermally controlled adaptive reflectors may be assembled within an array such as LAMA on the Moon, or in a very large aperture (>20 m diameter) infrared telescope or solar concentrator in space. Alternatively, a single reflector may be manufactured with thermal breaks of a material with low thermal conductivity between facets composing the reflector to achieve even more adaptive geometries for the reflector. More complex shapes than simple flat plates may be used such as the thermal breaks previously mentioned in addition to tapered layer thicknesses and alternating material types transitioning radially from the center of the reflector. Circular, hexagonal, or more complex shapes for each reflector may be implemented. Very large deployable mirror arrays in space may be achieved by implementing hinge joints between adjacent mirror elements such that the array unfolds into its operational configuration or through in-space assembly of many mirror elements to form the combined array.

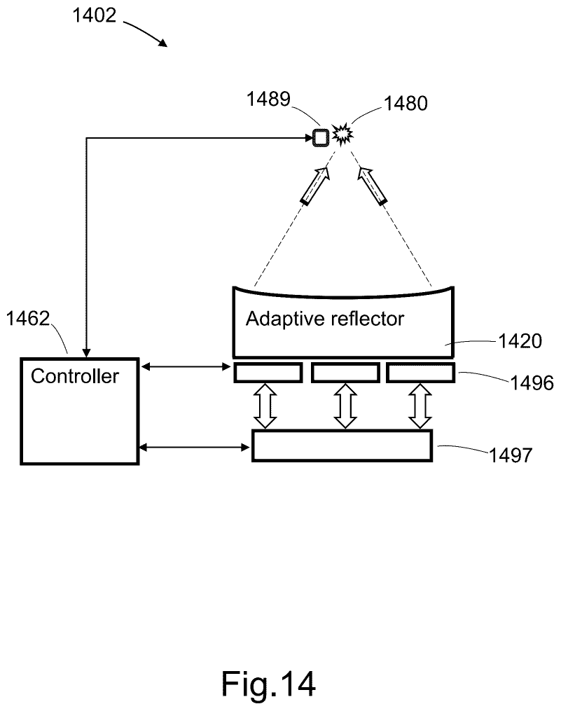

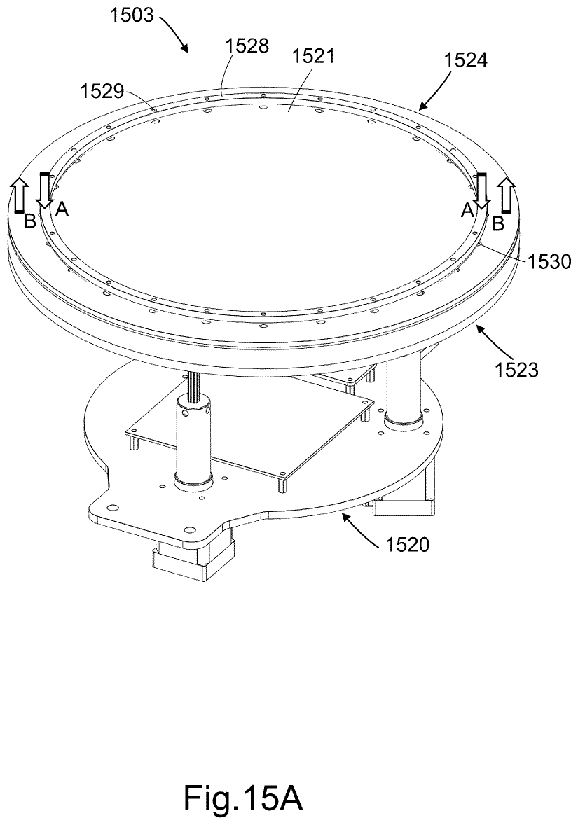

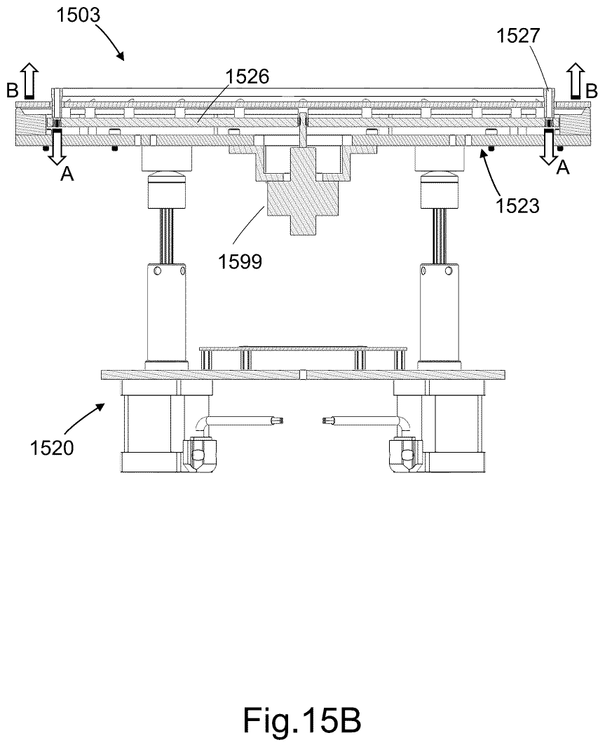

FIGS. 15-18C describe aspects of several embodiments of an annular force controlled concentrating reflector of a variable focal length optical system. The annular force controlled concentrating reflector operates to produce concentrated light at a selectable focal length. The selectable focal length may be dynamically adjusted or controlled through mechanical means (versus the thermal means of the thermally controlled adaptive reflector of FIGS. 13-14).

With attention to FIG. 14, an adaptive reflector system 1402 comprises an adaptive reflector body 1420, a controller 1462, an illumination spot sensor 1489, a set of mechanical couplers engaged with the adaptive reflector body 1420, and one or more actuators engaged with the mechanical couplers. The mechanical couplers are configured to manipulate or adjust the adaptive mirror body to vary the sag and/or focal length of the adaptive reflector body 1420. The controller controls the actuator 1497 and mechanical couplers 1496. The illumination spot sensor 1489 is configured to measure an illumination spot character 1480, the measurement provided by the illumination spot sensor 1489 provided to the controller 1462. The controller 1462 may use the measure from the spot sensor 1489 to determine an inferred sagitta of the parabolic shape, which may be used by the adaptive reflector system 1402 to adjust the adaptive reflector body 1420.

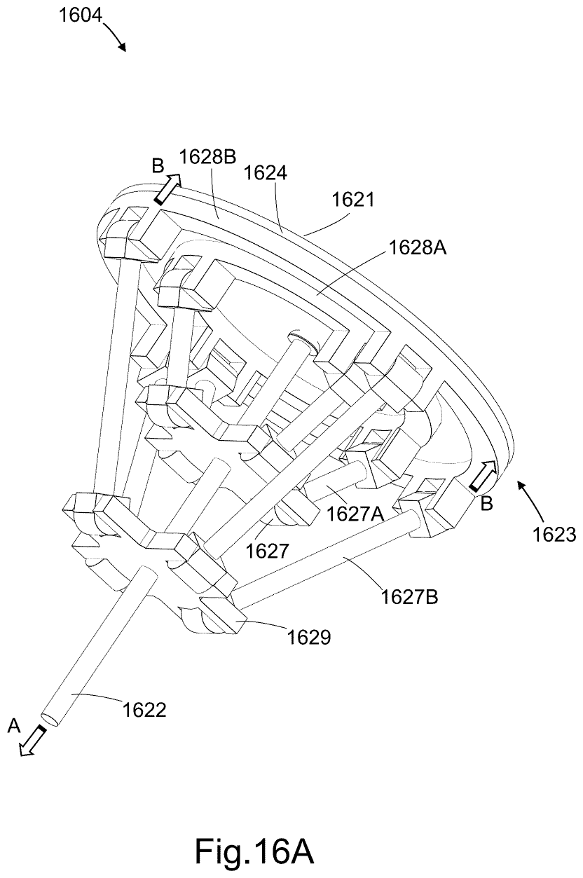

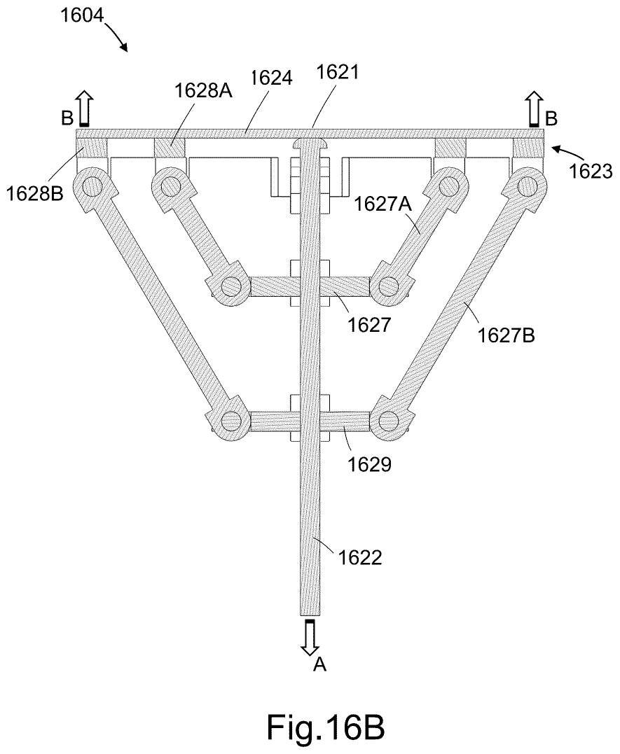

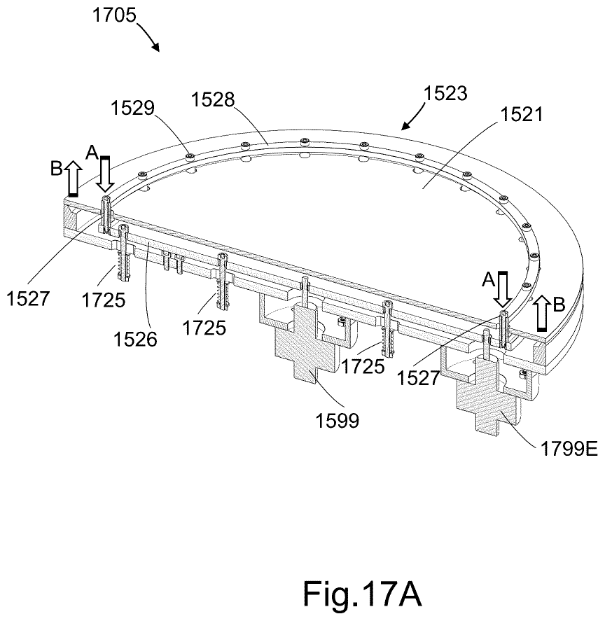

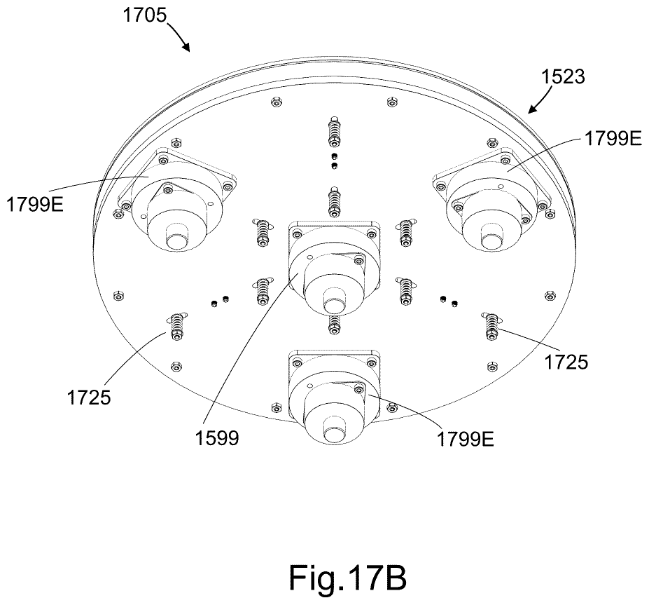

FIGS. 15A-B and FIGS. 17A-B depict an annular controlled adaptive reflector system 1503 and 1705, respectively, which employ an annular ring 1528 to impart a parabolic shape to an outer mirror surface 1521 of a mirror plate 1524 of an adaptive reflector body 1523, 1723. FIG. 16 depicts an annular controlled adaptive reflector body 1623 that is similar to the annular controlled adaptive reflector body 1523 yet instead of using a pull plate 1526 to impart a set of opposing forces to create a parabolic shape to its mirror plate 1624 with an outer mirror surface 1621, a set of struts and strut rings are utilized.

Note that in both the ring and strut embodiments of an annular controlled adaptive reflector system, a ring of forces is applied at the edge of disk or plate reflector (forces B in FIGS. 15A-B) and an opposing ring of forces (forces A in FIGS. 15A-B) induces mechanical strains in the mirror to achieve a near-parabolic shape. The resulting parabolic shape of the mirror enables both on-axis and off-axis solar concentrating reflector geometries across a range of focal lengths. One design (1503) to achieve these opposing forces is to manufacture a series of slots within the mirror at a distance from its edge as shown in FIGS. 15A-B and 17A-B. A ring located at the front surface of the reflector is used to pass fasteners through the reflector with these fasteners then connected to a pull plate or a series of struts either of fixed length or variable length. The pull plate or struts are then connected to a linear actuator which is coupled either to the center of the mirror and/or to the edge of the mirror to thereby apply a set of force directed towards the front surface of the mirror by the front ring and an opposing force to the center of the mirror or set of forces to the edge of the mirror.

The annular controlled adaptive reflector system 1503 comprises a mirror plate 1524 with an outer mirror surface 1521 and a set of slots 1530, a ring 1528 comprising a set of apertures 1529 passing through the ring 1528 and configured to align with the slots 1530 of the mirror plate 1524, a set of fasteners 1527 (which in one embodiment, are pins) passing through the set of apertures 1529 and the set of slots 1530 and configured to attach or couple to the pull plate 1526, a pull plate 1526 connected to the set of fasteners 1527, a pull plate actuator 1599 connected to the pull plate 1526, the pull plate actuator 1599 operating to impart a pulling force A to the pull plate 1526, resulting in a push force B imparted to the outer circumference of the mirror plate 1524 to result in the outer mirror surface 1521 forming a parabolic (or other) shape. The adaptive reflector body 1523 is engaged with an actuator assembly 1520 operating to position an orientation of the adaptive reflector body 1523. The actuator assembly 1520 may be any of several types of actuator systems known to those skilled in the art. In one embodiment, the actuator assembly 1520 is a linearly unconstrained magnetic joint actuator assembly, such as described in US Pat. Appl. Publ. 2019/0086634 entitled “Laterally Unconstrained Magnetic Joint for Tip-Tilt and Piston-Tip-Tilt Mounts” to Krylov, incorporated by reference in entirety for all purposes. The ring 1528 is disposed on or coupled to the outer mirror surface 1521 at a circumference of the outer mirror surface 1521 less than the full circumference of the mirror surface 1521. Stated another way, the ring 1528 fits within the diameter of the mirror surface 1521. The ring is positioned co-axial with the mirror surface 1521.

The annular controlled adaptive reflector system 1705 of FIGS. 17A-B is similar to the annular controlled adaptive reflector system 1503 with the exception of the addition of three extra actuation motors 1799E and a set of puller springs 1725. The set of puller springs 1725 are connected to the pull plate 1526 at a plurality of circumferences of the pull plate 1526, the set the puller springs 1725 imparting a pretension to the pull plate 1526.

The set of puller springs 1725 reduce the force required by the actuator(s) in deforming the force controlled adaptive mirror while reducing aberrations across the range of deformations. In one embodiment, additional springs between the backside of the mirror and the frontside of an opposing plate are provided. In practice, this design can lead to a sandwiched mirror design with deformable materials between the mirror and a backer plate.

With attention to FIGS. 16A-B, another embodiment of an annular controlled adaptive reflector body 1623 is described. The annular controlled adaptive reflector body 1623 is similar to the annular controlled adaptive reflector body 1523 yet instead of using a pull plate to impart a set of opposing forces to create a parabolic shape to its mirror plate 1624 with an outer mirror surface 1621, a set of struts and strut rings are utilized.

An outer strut ring 1628B is coupled to a lower surface of the mirror plate 1624 by way of a bonded layer or connection to the set of fasteners (not shown) and connected to a set of outer struts 1627B, which in turn are connected to a lower central plate 1629. The lower central plate 1629 is configured to allow a central axle 1622 to pass through it. An inner strut ring 1628A is also coupled to the lower surface of the mirror plate 1624 and connected to a set of inner struts 1627A, which in turn are connected to an upper central plate 1627. The upper central plate 1627 is also configured to allow a central axle 1622 to pass through it. An actuator (not shown) operates to actuate or move the central axle 1622 to in turn move the inner struts. When the axle 1622 is pulled away (the pull force AA) from the mirror plate, a pulling force A is imparted to the inner strut ring 1628A, wherein a push force B is imparted to the outer strut ring 1628B and the mirror plate 1624 forms a parabolic shape.

Note that each of the inner strut ring 1628A and the outer strut ring 1628B are attached to or coupled to the rear surface of the mirror plate 1624 by any of several means known to those skilled in the art, to include by way of a compliant foam tape which imparts normal forces to the mirror plate with minimal shear that would otherwise confine lateral deformation of the mirror plate. Stated another way, in one embodiment, a compliant interface material is provided to bond the inner ring to the backside of the mirror to prevent the mirror from becoming laterally constrained by the inner ring and allow pure normal forces with minimal shear between the back of the mirror and the inner ring. In one embodiment, the outer ring does not require any bonding with the mirror plate.

Note that in Earth applications of the disclosed adaptive reflectors, such as in a large heliostat array for a concentrated solar tower, the heliostats may be pointed to a target monitored by camera. An automated routine may be used to analyze the spot produced and infer reflector shape. Inferred and ideal reflector shape are then compared in an automated fashion, with instructions given to a ground operator at the heliostat for which struts or linkages may be adjusted for deforming the mirror to improve the spot quality. No electronic actuators are required for deforming the mirror in this terrestrial case, only mechanical forces applied via tightening or loosening fixtures. The feedback from the automated routine to the operator may be improved through use of an augmented reality display of the struts or linkages which require adjustments and by how much they should be adjusted.

Large deformations of the reflector can lead to high stresses and failure of the glass substrate. To achieve a larger sagitta for the reflector and consequently shorter focal lengths for the mirror, or to reduce the force required by the focal adjustment actuator(s), a manufacturing method can be applied for placing the glass substrate within an annealing chamber to heat to above the softening temperature of the glass and cause the substrate to slump over a master mold to assume a near-parabolic shape. In the case of the annular pull method, a parabolic shape can be pre-formed in the mirror with a focal length which is greater than the maximum focal length required by the mirror. The applied forces then cause this focal length to decrease, however with less stress applied to the mirror and lower forces required by the actuator.

This approach of slumping and pre-forming a parabolic shape for the mirror enables a different form of adaptive actuation of the mirror. Rather than a pulling force being applied to a ring at the front side of the reflector, the reflector can be secured from its frontside along its outer boundary and a pushing force can be applied to the backside of the reflector to increase focal length of the reflector. For this second approach for applying opposing sets of forces on the mirror, the glass substrate is again annealed and slumped over a master mold, but in this instance a parabolic shape is assumed whose focal length is less than the shortest focal length required from the reflector. Forces applied to the back of the reflector are then induced to reduce the sagitta and increase the reflector's focal length to the desired distance.

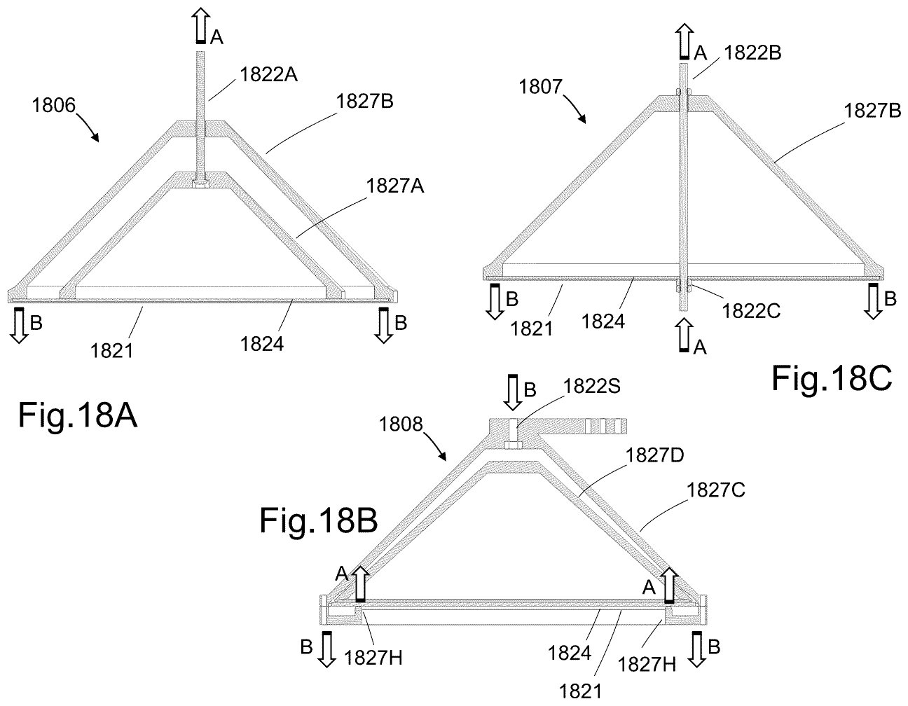

FIGS. 18A-C depict the physics of opposing sets of forces in three embodiment of an annular controlled adaptive reflector system. Each of the embodiments of FIGS. 18A-C comprise a mirror plate 1824 with outer mirror surface 1821.

The annular pull embodiment of the annular controlled adaptive reflector system 1806 of FIG. 18A presents the pull force A resulting in an annular push B of the outer mirror surface 1821. The pull force A provided to central axle 1822A imparts a pull force to inner structure 1827A which translates to a pull force on an inner circumference of the mirror plate 1824. The outer structure 1827B does not receive the pull force A but, given a coupling to an outer circumference of the mirror plate 1824, translates to a push force B on an outer circumference of the mirror plate 1824, thereby creating a parabolic shape to the mirror plate 1824 and thus to the outer mirror surface 1821.

The point pull embodiment of the annular controlled adaptive reflector system 1807 of FIG. 18B presents the pull force A resulting in an annular push B of the outer mirror surface 1821. The pull force A provided to central axle 1822B imparts a pull force to the collar 1822C positioned and coupled to the center point of the mirror plate 1824; this pull force translates to a pull force on an inner, central portion of the mirror plate 1824. The outer structure 1827B does not receive the pull force A but, given a coupling to an outer circumference of the mirror plate 1824, translates to a push force B on an outer circumference of the mirror plate 1824, thereby creating a parabolic shape to the mirror plate 1824 and thus to the outer mirror surface 1821.

The annular push embodiment of the annular controlled adaptive reflector system of FIG. 18C presents the push force B resulting in an annular push B of the outer mirror surface 1821. The push force B provided at central axis structure 1822S imparts a push force to the outer structure 1827C which is coupled to a maximum outer circumference of the mirror plate 1824; this push force translates to a pull force A at hinge circumference 1827H. Inner structure 1827D retains the mirror plate 1824 at an outer circumference just inside or less than the maximum outer circumference of the mirror plate. These forces result in a parabolic shape to the mirror plate 1824 and thus to the outer mirror surface 1821.

The exemplary systems and methods of this disclosure have been described in relation to systems and methods involving a tracking lunar articulating mirror array system for precise and controlled operations involving lunar regolith. However, to avoid unnecessarily obscuring the present disclosure, the preceding description omits a number of known structures and devices, and other applications and embodiments. This omission is not to be construed as a limitation of the scope of the claims. Specific details are set forth to provide an understanding of the present disclosure. It should however be appreciated that the present disclosure may be practiced in a variety of ways beyond the specific detail set forth herein.

A number of variations and modifications of the disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, sub-combinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An adaptive reflector system comprising:
an adaptive reflector body comprising:
a mirror plate comprising an outer mirror surface;
a ring coupled to the outer mirror surface at an inner circumference of the outer mirror surface, the ring configured with a set of apertures passing through the outer mirror surface;
a set of fasteners passing through the set of apertures; and
a pull plate connected to the set of fasteners;
at least one actuator connected to the pull plate, the at least one actuator operating to impart a pulling force to the pull plate;
wherein:
when a push force is imparted to the outer circumference, the mirror plate forms a parabolic shape.

2. The system of claim 1, wherein the at least one actuator is connected to the pull plate at a central axis of the adaptive reflector body.

3. The system of claim 1, wherein the adaptive reflector body further comprises a set of puller springs connected to the pull plate at a plurality of circumferences of the pull plate, the set of puller springs imparting a pretension to the pull plate.

4. The system of claim 1, further comprising an actuator assembly operating to position an orientation of the adaptive reflector body.

5. The system of claim 1, further comprising an illumination spot sensor configured to measure an illumination spot character provided to the controller, wherein the controller determines an inferred outer mirror surface shape.

6. An adaptive reflector system comprising:
an adaptive reflector body comprising:
a mirror plate comprising an outer mirror surface;
a ring coupled to a lower surface of the mirror plate at an inner circumference of the mirror plate;
an outer strut ring coupled to a lower surface of the mirror plate; and
an inner strut ring coupled to the lower surface of the mirror plate;
a set of outer struts connected to the outer strut ring;
a set of inner struts connected to the inner strut ring;
at least one actuator coupled to the set of inner struts, the at least one actuator operating to impart a pulling force to the inner strut ring;
wherein:
when a push force is imparted to the outer strut ring, the mirror plate forms a parabolic shape.

7. The system of claim 6, wherein the adaptive reflector body further comprises a set of puller springs connected to the inner strut ring, the set of puller springs imparting a pretension to the inner strut ring.

8. The system of claim 6, further comprising an actuator assembly operating to position an orientation of the adaptive reflector body.

9. The system of claim 6, further comprising a protective layer disposed on the outer mirror surface.

10. The system of claim 6, further comprising an illumination spot sensor configured to measure an illumination spot character provided to the controller, wherein the controller determines an outer mirror surface shape.

11. An adaptive reflector system comprising:
an adaptive reflector body comprising a front surface portion having a first thermal expansion coefficient and a substrate portion having a second thermal expansion coefficient, the adaptive reflector body having a first sagitta with a first focal length when the adaptive reflector body is at a first temperature and having a first outer reflective surface;
at least one thermal unit configured to set a thermal energy output and provide the thermal energy output to the adaptive reflector body, the thermal energy output is at least one of a heating output and a cooling output;
at one insulation layer positioned adjacent the at least one thermal unit and configured to absorb at least some of the thermal energy output; and
a controller configured to control the thermal energy output of the at least one thermal unit;
wherein:
the thermal energy output provided to or removed from the adaptive reflector body changes the adaptive reflector body to: i) a second temperature, and ii) a second sagitta with a second focal length.

12. The system of claim 11, wherein the controller receives a user selected focal length, and the user selected focal length is the second focal length.

13. The system of claim 11, wherein the at least one thermal unit is a plurality of thermal units comprising at least one embedded thermal unit positioned within the adaptive reflector body.

14. The system of claim 11, further comprising a protective layer disposed on the outer mirror surface.

15. A method of manufacture of an adaptive reflector comprising:
receiving a set of adaptive reflector operating requirements;
positioning a set of additive manufacturing tools and a set of manufacturing materials within a temperature-controlled chamber;
selecting a set of additive manufacturing parameters consistent with the adaptive reflector operating requirements;
performing additive manufacturing of the adaptive reflector within the temperature-controlled chamber using the set of additive manufacturing tools and the set of manufacturing materials;
removing the adaptive reflector from the temperature-controlled chamber;
wherein:
the performing additive manufacturing step secures a set of selectable thermal strains in the adaptive reflector, the set of selectable thermal strains consistent with the adaptive reflector operating requirements.

16. The method of claim 15, wherein the set of adaptive reflector operating requirements comprise a focal length at an operating temperature of the adaptive reflector.

17. The method of claim 15, wherein the set of manufacturing materials comprises a substrate and a front surface.

18. The method of claim 17, wherein the set of additive manufacturing parameters comprise a substrate thickness and a front surface thickness.

19. The method of clam 15, further comprising at least one of the steps of polishing the adaptive reflector and applying a protective layer to an outer surface of the adaptive reflector.

20. The method of claim 15, wherein the additive manufacturing is ultrasonic additive manufacturing.
